(19) United States
(12) Patent Application Publication
(10) Pub. No.: US 2024/0367059 A1
(43) Pub. Date: Nov. 7, 2024

(54) Virtual Reality (VR)-Enhanced Motion Platform, Experience Venue For Such Motion Platform, And Experience Content And Interactivity Ecosystem

(71) Applicant: Catalyst Entertainment Technology, Kitchener (CA)

(72) Inventors: Patrick W. BELLIVEAU, Kitchener (CA); Kurtis N. McBRIDE, Kitchener (CA); Gregory Russell MATTINSON, Kitchener (CA); Philippe Ernest MESZAROS, Kitchener (CA)

(73) Assignee: Catalyst Entertainment Technology, Kitchener (CA)

(21) Appl. No.: 18/778,211

(22) Filed: Jul. 19, 2024

Related U.S. Application Data
(63) Continuation of application No. PCT/CA2023/050052, filed on Jan. 19, 2023.
(60) Provisional application No. 63/301,092, filed on Jan. 20, 2022.
(60) Provisional application No. 63/307,691, filed on Feb. 8, 2022.

(51) Int. Cl. A63F 13/803; A63F 13/245; A63F 13/28; A63F 13/35

(52) U.S. Cl. CPC A63F 13/803; A63F 13/28; A63F 13/35; A63F 13/245; A63F 2300/8082

(57) ABSTRACT

A system is described, which includes an arena; at least one motion platform in the arena; at least one virtual reality headset coupled to each motion platform to integrate a combined virtual and physical experience; and an arena server to communicate with each motion platform and a global server. The system can also include the global server and/or at least one of a creator space, an audience environment, and a point of sale system to interact with the system via the global server. The system can also include a blockchain for tracking assets in the system. The blockchain can be used to mint and track revenue associated with non-fungible tokens (NFTs).

### CROSS-REFERENCE TO RELATED APPLICATION(S)

This application is a Continuation Application of PCT Application No. PCT/CA2023/050052 filed on Jan. 19, 2023, which claims priority to U.S. Provisional Patent Application No. 63/301,092 filed on Jan. 20, 2022, and to U.S. Provisional Patent Application No. 63/307,691 filed on Feb. 8, 2022, the contents of which are being incorporated herein by reference in their entirety.

### TECHNICAL FIELD

The following generally relates to virtual reality (VR)-enhanced experiences, in particular using a VR-enhanced motion platform. The following also relates to a local experience venue or location such as an arena for using such VR-enhanced motion platforms and an experience content and interactivity ecosystem for same. Such ecosystem can also integrate global audience or observer participation in live events within the ecosystem to provide bidirectional experiences.

### BACKGROUND

Humans experience reality via a variety of senses that all inform the brain. In its simplest form, the body relies on the nervous system and visual cues to understand what is happening and the limbic system layers context onto what is happening (e.g., good, bad, excited, scared, etc). Traditionally, amusement ride owners, go-kart operators, family entertainment centres and the like have had to contend with single experience platforms. This is particularly challenging given that their business model typically relies on throughput and consumer spend, but they have been required to make capital investments and real-estate commitments on the premise that market research is correct that a large percentage of their target audience will find the entertainment worth experiencing. This paradigm is resource intensive, relies on speculative consumer trend/analysis data, and is normally inflexible once launched, making it expensive to remedy a bad investment. This is coupled with the fact that the same type of model is likely suggesting what the next investment should be.

Virtual Reality (VR) has been around for decades but is currently experiencing unprecedented success in the market as VR headsets become less expensive and more mainstream. For example, previous norms in the industry, such as that headsets are expensive, that a highly capable computer is required, or that the headset must be connected via cable to such a computer, are being broken. This lowers the barrier to entry both from a cost perspective and a learning curve perspective (i.e., one can place the headset on their head and be guided as to how to operate the headset). These headsets allow users to experience new worlds through thrilling visual renders but, as discussed above, humans experience reality with more than just vision, and the nervous system plays a large role, which still presents challenges. For example, side effects of VR experiences can still include nausea since what the user is seeing does not align with their other senses, leading the body to believe it has been poisoned and triggering such nausea.

### SUMMARY

In one aspect, there is provided a virtual reality-enhanced motion platform, comprising: at least one drive unit to move the motion platform; at least one control system; a seating unit for a user; a steering mechanism controlled by the user to direct the at least one drive unit to move the motion platform; at least one virtual reality headset coupled to the motion platform and wearable by the user to integrate a combined virtual and physical experience; at least one communication module to communicate with a server to exchange data in providing an experience that operates the motion platform and virtual reality headset at the same time to provide the integrated virtual and physical experience; and a power source.

In an implementation, the motion platform includes at least one tracking module for tracking the motion platform within an arena in which the motion platform is being used.

In an implementation, the motion platform includes a plurality of swappable sub-systems or sub-components that are removable and replaceable.

In an implementation, the power source comprises a plurality of batteries, each battery being swappable from the motion platform.

In an implementation, the motion platform is configured to perform at least one motion in addition to planar translation: tilt, roll, yaw, heave, and/or haptic feedback.

In an implementation, the at least one drive unit comprises a plurality of swerve drive units to permit multi-directional movements.

In an implementation, the motion platform includes a plurality of seating units.

In an implementation, at least two seating units are independently moveable.

In another aspect, there is provided an arena for providing combined virtual and physical experiences, the arena comprising: a surface on which a plurality of motion platforms can move within the arena; a tracking system to track movements of the motion platforms relative to the surface and to each other; and an arena server to communicate with each motion platform to provide the combined virtual and physical experience.

In an implementation, the tracking system comprises a plurality of anchors communicable with tags on the motion platforms using a communication protocol.

In an implementation, the arena further includes at least one area separate from the surface to load and unload users.

In an implementation, the at least one area comprises a plurality of stations to each perform an unload, provisioning, loading or starting operation.

In an implementation, the arena server communicates with the motion platforms to provide asynchronous operations using the plurality of stations.

In an implementation, the arena server provides virtual reality content that varies depending on in which station is the motion platform.

In an implementation, wherein the arena server is in communication with a global server to enable motion platforms in multiple arenas to have the same experience.

In an implementation, the arena further includes an attendant area to permit attendants to interact with the motion platforms.

In another aspect, there is provided a system comprising: at least one motion platform in an arena; and a server to communicate with each motion platform by communicating with at least one virtual reality headset coupled to each motion platform to integrate a combined virtual and physical experience.

In an implementation, the system includes a motion platform as described above, in an arena as described above.

In an implementation, the server comprises an arena server.

In an implementation, the arena server communicates with a global server.

In an implementation, the system further includes the global server.

In an implementation, the system further includes a creator space.

In an implementation, the creator space enables users or other entities to create content for the virtual portion of the combined virtual and physical experience.

In an implementation, the system further includes an audience environment.

In an implementation, the audience environment enables at least one additional entity to provide content and/or view the combined virtual and physical experience from a virtual perspective.

In an implementation, the system further includes a point of sale system to permit assets to be purchased and sold.

In an implementation, the system further includes a blockchain for tracking assets in the system.

In an implementation, the blockchain can be used to mint and track revenue associated with non-fungible tokens (NFTs).

### BRIEF DESCRIPTION OF THE DRAWINGS

Embodiments will now be described with reference to the appended drawings wherein:

FIG. 1 is a schematic diagram of an experiential content and interactivity ecosystem in which VR-enabled motion platforms can be utilized in venues at local experience sites to provide simultaneous virtual and real world experiences.

FIG. 2a is a schematic diagram of a venue configured as an arena in which motion platforms can be used to provide experiences.

FIG. 2b is a schematic diagram illustrating an asynchronous activation process.

FIG. 3 is a pictorial illustration of a user interfacing with a generic representation of a motion platform.

FIG. 4 illustrates a tilting motion applied to or experienced by a motion platform.

FIG. 5 illustrates a yaw motion applied to or experienced by a motion platform.

FIG. 6 illustrates independent yaw motions applied to or experienced by separate portions of a motion platform or by separate motion platforms rendered together in the same gaming experience.

FIG. 7 illustrates an example of a motion platform configured as a steerable vehicle or racing car.

FIG. 8 illustrates a multi-player experience in which two users are either using the same physical motion platform or different virtual platforms rendered together virtually.

FIG. 9a is a schematic block diagram of an architecture for the motion platform.

FIG. 9b is a block diagram illustrating a motion platform having swappable sub-systems.

FIG. 10 is a flow chart illustrating computer executable instructions for initializing and operating a motion platform.

FIG. 11 is a schematic block diagram of an example of a configuration for a local arena server.

FIG. 12 is a flow chart illustrating computer executable instructions performed by the local arena server.

FIG. 13 is a schematic block diagram of an example of a configuration for a global server.

FIG. 14 is a flow chart illustrating computer executable instructions performed by the global server.

FIG. 15 is a schematic diagram of data exchanges between the arena and the local arena server and between the local arena server and the global server.

FIG. 16 is a schematic diagram of a communication architecture.

FIG. 17 is a schematic block diagram illustrating a localizing architecture.

FIG. 18 is a schematic block diagram of an example of a configuration for a creator space.

FIG. 19 is a flow chart illustrating computer executable instructions performed by the creator space.

FIG. 20 is a schematic block diagram of an example of a configuration for a point of sale (PoS) system.

FIG. 21 is a flow chart illustrating computer executable instructions performed by the PoS system.

FIG. 22 is a screen shot of a creator space user interface (UI) for selecting a prefab object for customization.

FIG. 23 is a screen shot of a creator space UI for selecting an arena size for the customization.

FIG. 24 is a screen shot of a creator space UI for a creator space UI displaying a canvas to add assets to the customization.

FIG. 25 is a further screen shot of a creator space UI for a creator space UI displaying a canvas to add assets to the customization.

FIG. 26 is a screen shot of a creator space UI for adding textures to the customized object.

FIG. 27 is a screen shot of a creator space UI providing a submission notification.

FIG. 28 is a screen shot of a creator space UI providing a verification message.

FIG. 29 is a screen shot of a creator space UI providing a non-fungible token (NFT) minting page.

FIG. 30 is a screen shot of a creator space UI for handling revenue associated with an NFT.

FIG. 31 is a screen shot of a UI for enabling audience participation through consumable NFTs, providing an event notification page.

FIG. 32 is a screen shot of an audience viewing UI used during an event.

FIG. 33 is a screen shot of a live event UI providing a drop zone map for enabling placement of consumable NFTs by audience members.

### DETAILED DESCRIPTION

To address at least some of the above challenges, the following describes a VR-enhanced motion platform, a local experience venue such as an arena in which to use such motion platforms (e.g., ride, explore, watch), and a wider experiential content and interactivity ecosystem with which to deliver VR-enhanced physical experiences that break one-to-one mappings between the virtual and physical worlds. The systems and methods described herein can be used to disrupt the single experience platform by combining VR, which lacks real G-forces, and haptic feedback, with a motion platform capable of real speeds and G-forces felt by the user's body, in contrast to simulators. The ecosystem and environments capable of being deployed and utilized according to the following systems and methods can address traditional problems with location-based entertainment venues, as well as further enabling virtually limitless experiences that VR headsets can deliver, which can include bidirectional experiences that involve global audience participation in events. The ecosystem can enable multiple arenas to play/race/experience the same event in the virtual environment, from different physical locations. Moreover, as discussed herein, the ecosystem can further integrate audience members that can view and/or participate with the arenas from another location such as from their home.

In this way, the same VR headset and motion platform can remain constant while the content can continually change to meet varying consumer demands both in real-time and over time. Given the appropriate visuals, the motion platform can be used to simulate experiences such as space exploration vehicles, race cars, boats, motorcycles, go-karts, military vehicles, etc. The motion platform can also be configured to interface with the human body in a way that simulates other experiences through haptic feedback mechanisms, for example, ziplining, skydiving, paintballing, etc.

The motion platform can be capable of either autonomous driving or being driven by a rider (or both) with fully integrated telemetry instruments and haptic feedback to ensure a frictionless experience between the physical world and the virtual world. The motion platform can also integrate various types of steering mechanisms (e.g., omni-directional, multi-directional, swerve, Ackermann, etc.), additionally combining tank-like steering with wheels independently controlled, as discussed further below. The system described herein with such autonomous driving capabilities and a persistent virtual world, can be leveraged to address activation bottlenecks by providing an asynchronous launch capability.

The data used or generated within the ecosystem can converge and be controlled by an experience engine to maximize safety and deliver exciting, customizable and shared experiences. The motion platform can utilize an “everything by wire” design where human actions are digital inputs to the system. The motion platform can also incorporate onboard cameras facing riders, which can be streamed to a video streaming platform such as Twitch™ along with additional digital content. The system can also be configured in such a way to only allow the human inputs to be actioned if they fall within an acceptable range, that is, to layer on appropriate readiness and safety checks and measures to enable a smooth experience in both the real and virtual worlds simultaneously.

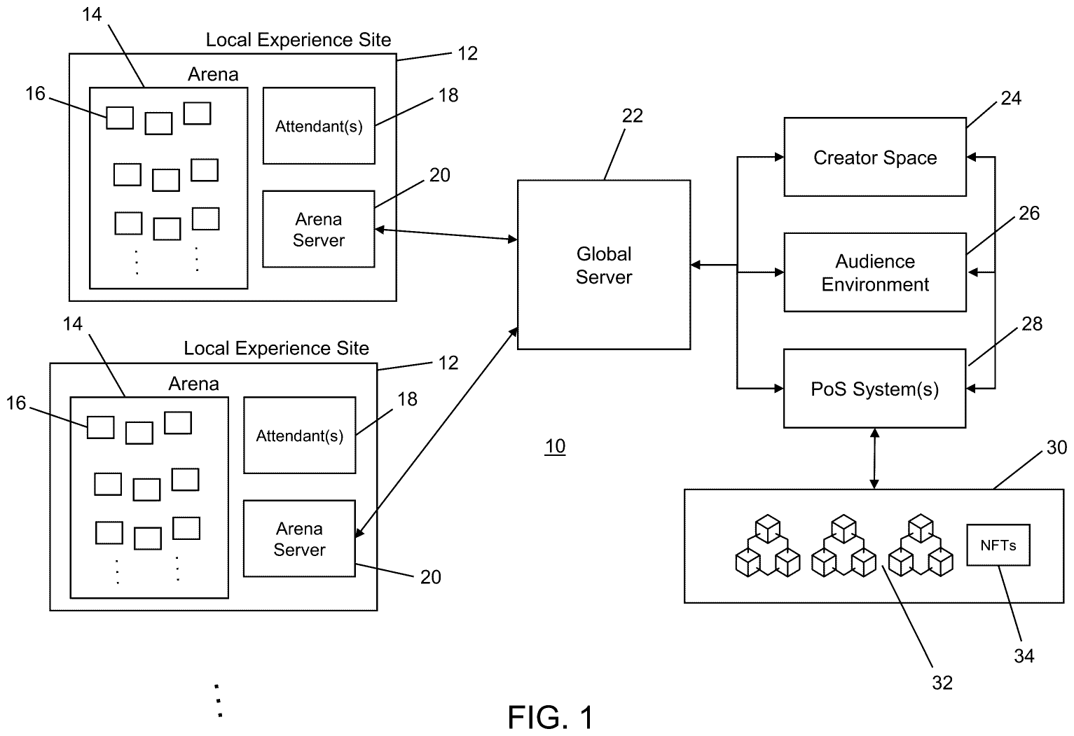

Turning now to the figures, FIG. 1 illustrates an experiential content and interactivity ecosystem (hereinafter referred to as the “system 10” for brevity), in which VR-enabled motion platforms 16 can be utilized in venues or other locations (such as arenas 14 as shown in FIG. 1) located at one or more local experience sites 12 to provide simultaneous virtual and real world experiences. It can be appreciated that the venues can vary based on the sizes of the arenas 14 and motion platforms 16. Each local experience site 12 in this example includes the arena 14, in which a number of motion platforms 16 are positioned and utilized to provide a simultaneous virtual and real world experience; and one or more attendants 18, which represents any staff or ancillary entities including humans and automated beings that control, supervise, intervene or otherwise interact with users and corresponding motion platforms 16 being used in the arena 14. Each local experience site 12 also includes a local arena server 20 to coordinate the exchange of game data, messages, communication packets, instructions/commands and any other data associated with providing the simultaneous virtual and real world experience in the arena 14. The arena server 20 is coupled to a global server 22, e.g., over a network or other communication connection.

Such communication connections may include a telephone network, cellular, and/or data communication network to connect different types of devices, including the motion platforms 16, arena server 20 and global server 22. For example, the communication network(s) may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The global server 22 as shown in FIG. 1 is coupled to any one or more local experience sites 12 in the system 10 (two being shown by way of example only) and can be used to ensure that games are only deployed to the appropriate arena servers 20 based on the arena type, the motion platform type, identify of the users (players), etc. The global server 22 also provides an interface between other entities in the system 10 and the local experience sites 12. For example, as shown in FIG. 1, this can include a creator space 24 to enable users (including participants and non-participants such as audience members) to create content such as digital assets, games, mini-games, skins, tracks, mechanics, tournaments, events and live experiences, etc. The system 10 can also include an audience environment 26, which can include a UI or app for audience users to connect into the system 10, e.g., to access a live event and/or to navigate to/from the creator space 24. The system 10 can also include one or more point of sale (PoS) systems 28 that enable users (including both participant players and others) to create user profiles, pay for digital assets, create an economy around an NFT, etc.

The PoS system(s) 28 can utilize or otherwise have access to a digital storage medium 30 to enable digital assets to be stored and accessed for monetization. In this example, the digital storage medium 30 is or includes a blockchain 32, which is a form of digital ledger to provide proof of ownership and to track digital asset sales and other revenue-generating events associated with the asset (e.g., rentals, licenses, etc.). The digital storage medium 30 and/or blockchain 32 can be associated with various digital assets such as NFTs 34 created and utilized within the system 10 as described in greater detail below.

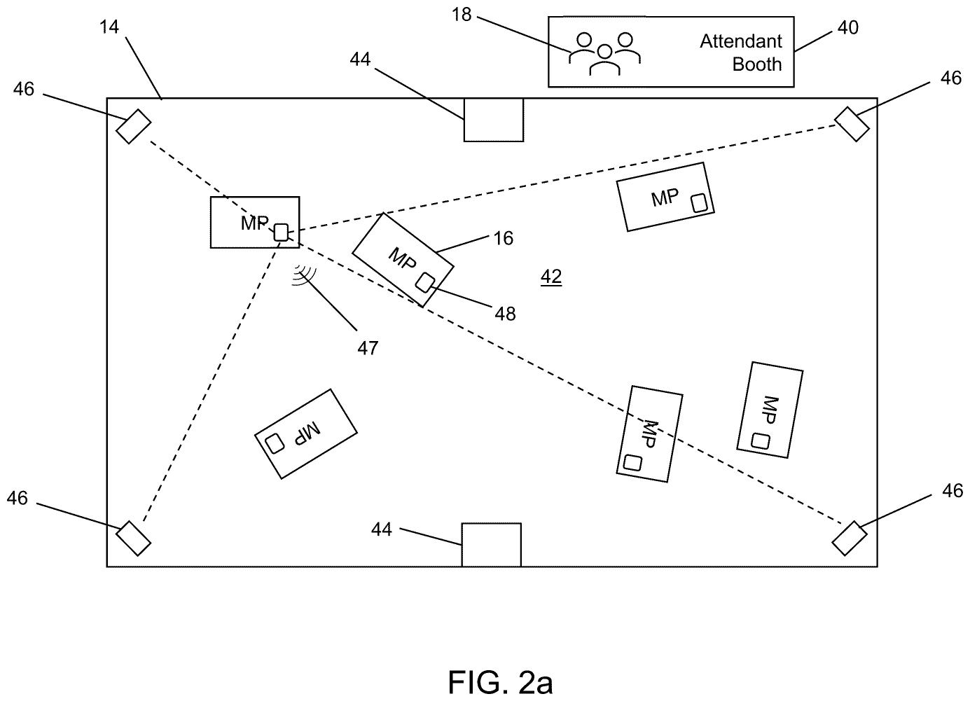

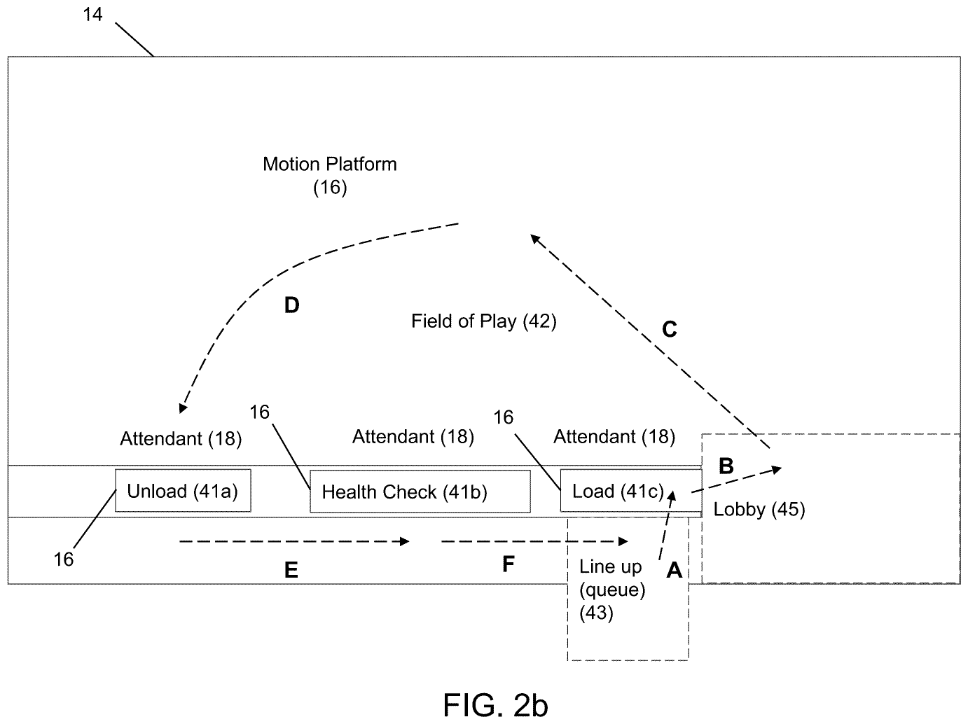

Referring now to FIG. 2, a schematic illustration of an arena 14 is shown. The arena 14 in this example is a portion of a local experience site 12 that includes an attendant booth 40 or other suitable structure or seating for one or more attendants 18 to monitor and control events in the arena 14. The building that houses the arena 14 can include card-swipe access control and doors controlled by the attendants 18 to permit players to enter and exit the arena 14 at the appropriate times. The arena 14 can be placed in a separate room with viewing screens to show what is seen in the virtual world, video cameras to record the motion platforms 16, etc. The arena 14 can also be devoid of windows and other ornamentation since the physical world of the arena 14 would not line up with what is seen in the virtual world.

The arena 14 can be custom built or retrofitted into an existing space. In this example, the arena 14 includes obstructions (in this instance a pair of pillars 44) that need to be accounted for when permitting movement of the motion platforms 16 within the arena 14, e.g., to avoid collisions with moving motion platforms 16 or otherwise obstructing the game play. The motion platforms 16 (shown using acronym “MP” in FIG. 2) can be controlled autonomously like an amusement “ride”, can be controlled manually by a user (aka a “driver mode”), or can be controlled using both manual and autonomous controls during a live experience (e.g., while gaming). For example, the motion platform 16 can be driven by the user but haptic feedback is automatically applied to the motion platform 16 to simulate a collision or crash, artillery impact, weather or other environmental impacts, etc. That is, the everything by wire configuration enables the motion platform 16 to be controlled by both the user/player and various outside entities, including the arena server 20, global server 22, audience environment 26, etc.

The arena server 20 can include an API for the motion platforms 16, e.g., for registration and health/error statuses, and a user datagram protocol (UDP) port for listening on the arena server 20 to reduce traffic, improve performance, and remove complications of maintaining (or establishing) a transmission control protocol (TCP) connection. This can be done by having the motion platforms 16 broadcast UDP packets to other motion platforms 16 or have the motion platforms 16 broadcast to the arena server 20, which can then repeat the communication. That is, a UDP port on the arena server 20 can have matching UDP ports listening on each motion platform 16 to allow broadcast traffic to be used to reduce network latency and bandwidth requirements. For broadcasts between motion platforms 16, suitable access points and additional servers can be utilized if necessary or desired. The arena server 20 can also provide a web server/service for local staff that shows the arena 14, which experience is being provided using each motion platform 16, errors received from the motion platforms 16, provides an override to eject customers from an experience such as a game, stop and go buttons, etc. The arena server 20 can also communicate with experience engines running on onboard central processing units (CPUs) in the motion platform(s) 16 or VR headsets (e.g., Unity game engines or equivalent experience or “metaverse” engines) that can poll a tracking system (e.g., ultra-wideband (UWB) tracking) for location information.

It can be appreciated that the “experience engines” running on onboard CPUs, which can be implemented using game engines or equivalent devices (e.g., Unity™), can be configured to run, at least in part, the physical device implemented as a motion platform 16, which is in contrast to traditional uses of such devices that are purely digital. The experience engine and/or outputs therefrom can be used to manage the motion platform 16 to ensure contextually appropriate visuals are available virtually and that are aligned with the physical world. For example, consider a jungle cruise theme and the motion platform 16 needs to stop to allow another motion platform 16 through. Since, the experience engine on the onboard CPU(s) have access to both the motion platform 16 and the visuals, it can render a Gorilla in front of the rider to justify the stop. In another example in which the motion platform 16 is simulating a flight experience, the degree of incline in the physical world needs to match the virtual world to ensure the user's body truly believes what is happening.

The experience engine can send movement commands to all other registered motion platforms 16 if: collision avoidance is necessary (limits maximum speed & steering options), auto driving is occurring (forces specific speed & steering), local driving can resume (cancels previous limit settings), game start/stop (communicated as limit=0), and commands are constantly sent so the motion platform 16 knows arena server 20 is still active, to name a few. The experience engine can also be connected via the arena server 20 to the aforementioned access control system to stop the game when an arena door is opened. The experience engine, via the arena server 20 also communicates with the global server 22 for coordinating games between sites, etc. Collision avoidance can be resolved locally without involvement from the global server 22 in some implementations.

An autonomous mode allows for multiple experiences to be rendered simultaneously on the same physical plane, with an autonomous motion platform 16 actively avoiding other motion platforms 16 or “drivers”. Given the experience engine operating on the onboard CPU is actually controlling the motion platform 16, if the motion platform 16 needs to stop unexpectedly, the experience can provide a contextually appropriate visual to help the user understand the sudden movement. For example, if the player is on a jungle cruise and the motion platform 16 needs to rapidly adjust course by stopping, the game can display an animated gorilla as the virtual “reason” for the stop.

In either autonomous mode or driver mode, the architecture of the motion platform 16 can be configured to allow forward and backward tilting as well as typically translational movements along the ground-engaging plane on which it is operating. Combining a contextuality appropriate tilt and rendering the relevant angles in VR can allow the user to feel like they are rising in altitude, akin to how humans sense that they are rising in altitude in an aircraft, yet do not see the ground or the sky for visual cues. This allows players to be on a multitude of planes while never leaving the ground. Furthermore, where the user is in the virtual world does not need to match where they are in the physical world.

For example, a user can be racing shoulder to shoulder with someone in VR, while being ten feet apart in the “real world” (or technically be anywhere in the real world), as long as an offset algorithm is present in the virtual world. This allows the system 10 to, in a way, simulate or replicate certain laws of physics since a participant on a higher plane can drive directly over a participant on a lower plane (e.g., the user can look down/up and see them) because where they are in the physical world is fundamentally different from the virtual world. The system 10 allows content creators and content providers to simulate in-game accidents vs. the traditional “real” collision that occurs in traditional go-karting or bumper cars, making it much safer. Furthermore, the system 10 can allow the game to manipulate the motion platform 16 as it sees fit, for example if the player hits a virtual oil spill, the motion platform 16 can slow down and spin—no matter what the player is trying to do. In another example, if a player takes on virtual “damage” on the virtual motion platform, the physical motion platform 16 can become limited its ability accordingly. For instance, in a tank war where a player takes on damage on the left side, the motion platform 16 abilities can be adjusted to have its turning radius go from 180 degrees to 90 degrees. It can also further limit the player, say for example the player takes on virtual damage, the system 10 can lessen the output power of the motor, limit the steering vectors, etc.

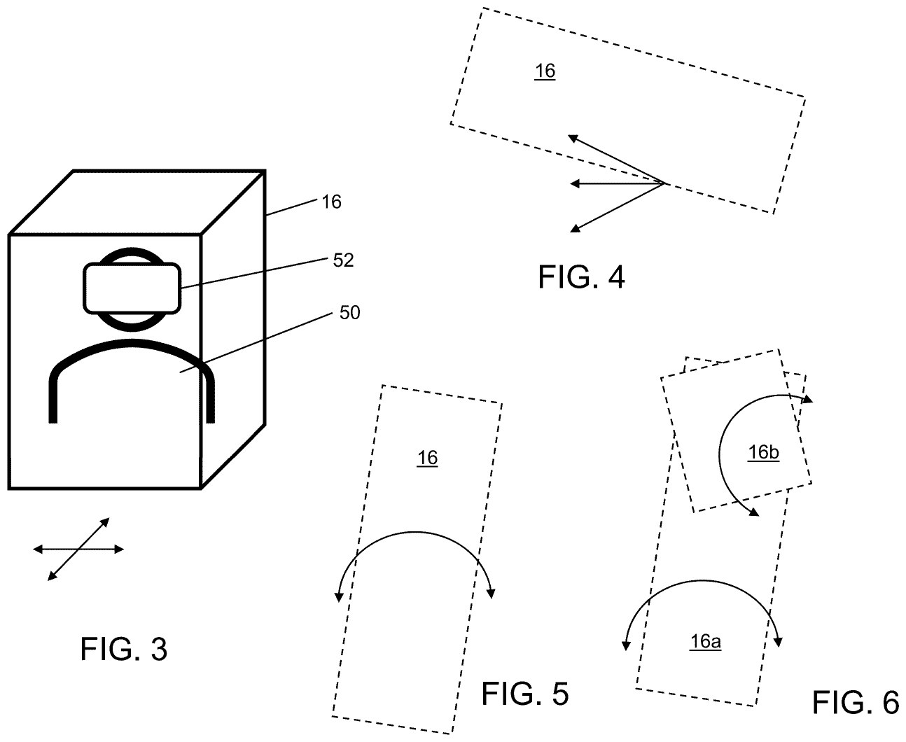

Coupling the motion platform 16 with VR headsets (52—see also FIG. 3) breaks many traditional one-to-one (1:1) relationships, such as one experience per platform or physical layout. For example, currently it may be possible for a traditional go-kart track to allow its users to climb in altitude, but this would require at least a two story building with a ramp for riders to drive up. Furthermore, to change the track for the riders requires a redesign and change to the physical track and barriers. In contrast to these challenges, the system 10 described herein can deliver all of the experiences on a single flat surface and change the tracks in software instead of requiring such physical and potentially capital intensive changes.

The arena 14 can be designed and sized to fit a desired layout for a particular experience, or experience(s) can be adapted to retrofit into a given arena 14. For example, an existing amusement provider may have an existing building into which they want to create an arena 14 with a play area or field of play 42, which may include obstructions 44 such as the pillars shown in FIG. 2a. By breaking the one-to-one relationships normally required, the motion platforms 16 can be more adaptable to different environments while taking up less space than a traditional physical amusement attraction.

For example, it is expected that an arena 14 having 18,000 sq ft would be sufficient to host a minimum of twenty (20) motion platforms 16 where users can race against each other, play as a team against a common enemy, or play against each other in various scenarios within the field of play 42, to name a few.

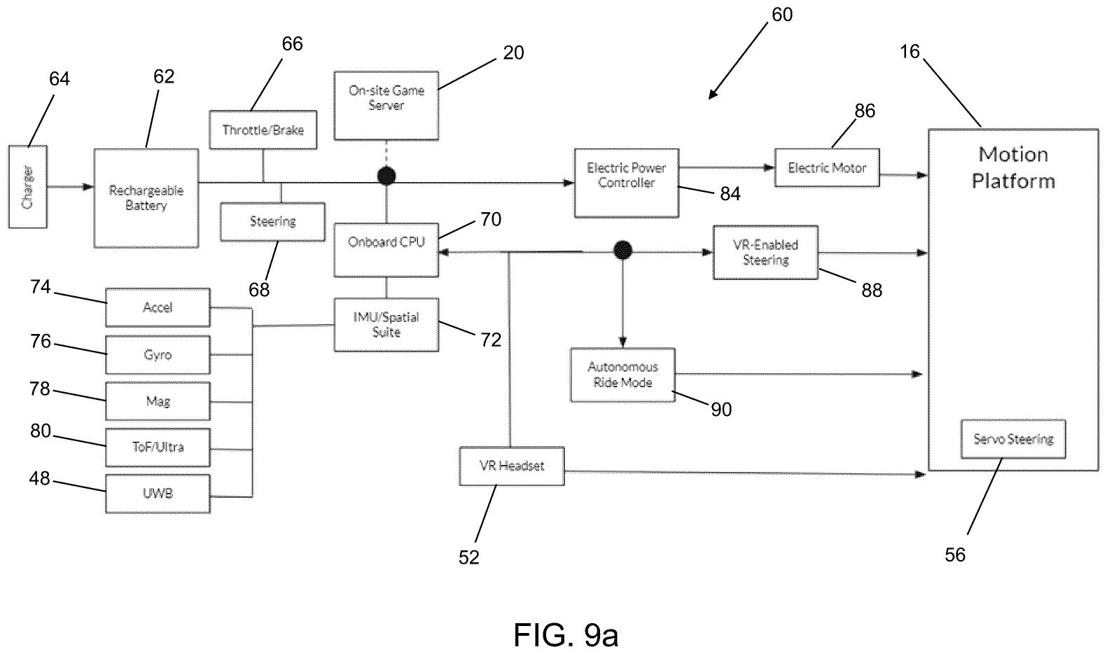

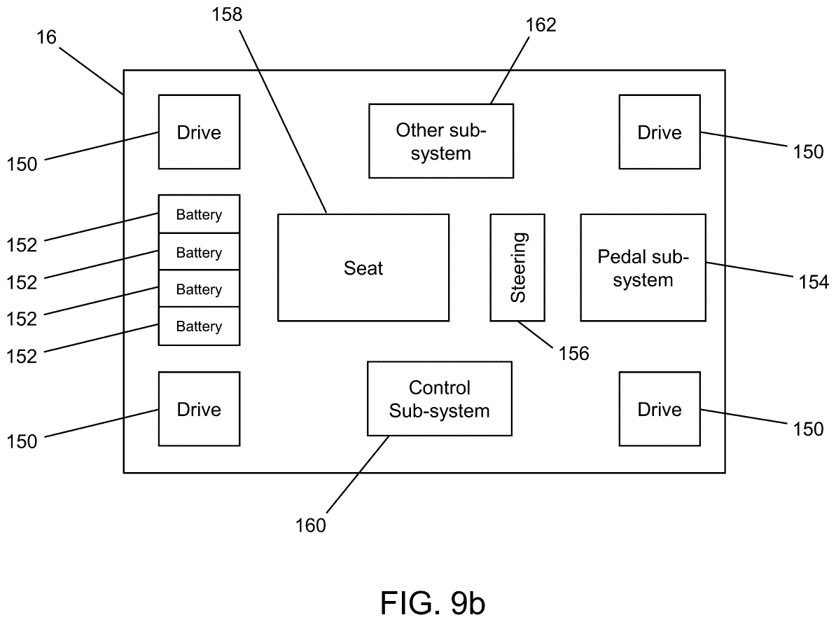

Since the motion platforms 16 are blending both physical and virtual experiences and are moving within the arena 14 at the same time as other motion platforms 16, the motion platforms 16 need to be tracked in order to align the physical movements and haptic feedback with the virtual environment in which the user is playing (see also FIG. 9 described below). In this example, the motion platforms 16 can include their own tracking feature 47 such as time-of-flight, lidar, etc., and the arena 14 includes a tracking system used to track the positions of the motion platforms 16 within the arena 14. In this example, the tracking system includes a set of UWB anchors 46 that detect and register movements of the motion platforms 16 using UWB tags 48 on the motion platforms 16 themselves. A UWB system can also utilize a server and ranging software, which can be provided via the arena server 20. As is known in the art, in an UWB system, the mobile tags 48 use UWB radio technology to communicate with the anchors 46 that are placed around the tracking area (in this example the arena 14). The tag 48 chooses anchors 46 based on self-learning algorithms from which the distances are calculated. Based on the distances measured, the coordinates are calculated in the arena server 20 using self-learning algorithms.

The arena tracking system can also use other techniques for moving objects, such as odometry, inertial navigation, optical tracking, and inside-out tracking to name a few. Odometry involves using a sensor (such as a rotary encoder or shaft encoder) to keep track of how much the wheels have rotated, in order to estimate how far the vehicle has moved. Even without sensors, it's possible to do a very rough estimate based on how fast the vehicle is moving as well as the steering direction. Odometry is known to work well with rigid wheels on vehicles that move in straight lines but can be more difficult to implement when tires are inflated or the tracks include curved paths. As such, odometry may be an option for certain types of games in certain types of arenas 14.

Inertial navigation uses an accelerometer to track motion. At a given sample rate (e.g., 100 Hz) one can read the acceleration vector. The acceleration is multiplied by the time since the last sample to get the current velocity, and that velocity is multiplied by the time since the last sample to get the change in position. Since inertial navigation accuracy can degrade over time but provides an option for certain types of games with vehicles that move more quickly. Odometry and inertial navigation are relative tracking systems, namely they measure the change in position rather than the absolute position. This is in contrast to tracking systems such as UWB that utilize absolution positions. Alternative absolute positioning systems can include optical or magnetic tracking or inside-out tracking. Inside-out tracking uses cameras on headsets worn by the users (or on whatever object is being tracked) and natural feature points (e.g., edges and corners) in the surroundings to provide a reference for the tracking system. Inside-out tracking can be an appropriate technique in smaller areas or where the natural tracking points do not move too fast relative to the camera's frame rate.

In the present disclosure, the arena 14 is configured with an UWB tracking system, although as discussed above, other suitable tracking systems can be deployed according to the game type, motion platform 16 and arena 14 being used.

With respect to throughput of users at the arena 14, it has been recognized that amusement parks have been known to struggle with the limited throughput from VR activations or other activities such as go kart activations. These types of activations typically follow the same principle of synchronous game launch, that is, each player begins and ends at roughly the same time. For example, if you have twenty (20) go karts, an operator can only be as efficient as the time it takes the attendants 18 to unload twenty drivers, sanitize or otherwise prepare twenty go karts for next use, and load in twenty new drivers. Continuing with this example, traditionally the only way to expedite this process would be to have an additional twenty go karts being loaded while twenty are out in the field of play 42. In other words, the only way to expedite the current activation process is to double the fleet of units, which increases capital expenditure for that attraction. The system 10 described herein can be leveraged to address this activation bottleneck by providing an asynchronous launch capability. Referring now to FIG. 2b, an asynchronous launch can be made possible by leveraging both the persistent virtual world within the field of play 42, and the motion platforms 16 capable of autonomous driving/movement.

The asynchronous launch process flow enables an attendant 18 to load a user 50 from a line up or queue 43 into/onto a motion platform 16, whereupon a custom or otherwise pre-set on-screen timer starts while the user 50 then enters a lobby 45. It can be appreciated that the on-screen timer can be set to any desired amount of time, e.g., according to the number of motion platforms 16 used during an experience. In the lobby 45, the user 50 has an opportunity to better familiarize themselves with the motion platform's capabilities and can be held there before entering the active field of play 42.

Once comfortable or after a certain amount of time elapses, introductory content ends, etc., the user 50 can leave the lobby 45 and enter the field of play 42 to enjoy the persistent VR world according to the particular experience being played at that time and at that venue. Typically, the experience is time limited and thus once the timer runs out (or the experience otherwise ends), the motion platform 16 can be activated to autonomously drive the user 50 to an unload 41a section where an attendant 18 helps the user 50 unload themselves from the motion platform 16. Once unloaded, the score or other metric resets (e.g., score based experience), and the motion platform 16 can begin preparations for the next user 50 to be loaded, in this case by autonomously driving to a health check station 41b, where an attendant 18 (the same or another attendant 18) sanitizes or otherwise resets/reloads/prepares the motion platform 16. This can include other operations such as checking to see if the motion platform 16 requires new batteries. For example, if the motion platform 16 needs new batteries, the attendant 18 (the same or different attendant 18) can quickly remove any depleted batteries and replace them with charged ones. Once through the health check station 41b, the motion platform 16 autonomously drives to a load station 41c to continue the cycle of accepting the next user 50 from the queue 43.

By having the persistent virtual experience that breaks the one-to-one mappings between the virtual and physical worlds, and the ability to drive/move the motion platforms 16 autonomously as described in greater detail herein, the asynchronous launch described above beneficially allows a single (or fewer) attendant(s) 18 to focus on individualized tasks one at a time. Due to the autonomous capability, this allows for unload 41a, health check 41b, and load 41c to occur in parallel, which greatly reduces the time required to move a user 50 through the experience.

The following is an example mathematical example to illustrate the time gains achievable using the asynchronous launch. In this example, assume the operator has set an on-screen clock to 3 minutes, and that the unload station 41a consume about 25 seconds, the health check station 41b consumes about 15 seconds, and the load station 41c consumes about 30 seconds. Because these sections are now able to be executed in parallel, on the critical path one only needs to account for the longest pole, which in this case is the load station 41c consuming 30 seconds. This means a single motion platform 16 can deliver a throughput of seventeen (17) users per hour, based on the following calculation: 60 minutes/(3 mins+30 seconds)−rounded down.

FIG. 2b also illustrates, using dashed lines, an example of an asynchronous launch process utilizing the system 10 described herein. At step A, the next user 50 in the queue 43 is loaded into a motion platform 16 in the load station 41c and at step B enters the lobby 45 to familiarize themselves with the motion platform 16. At step C, the motion platform 16 enters the field of play 42 to begin their experience. When the experience completes (e.g., time is up, game is over, etc.), at step D, the motion platform 16 is autonomously driven to the unload station 41a to unload the user 50. It can be appreciated that the persistent virtual world can allow the operator to stagger the initiation of steps C and D to provide a more continuous procession back to the queue 43 to load the next user. The motion platform 16 moves through the stations 41b and 41c at steps E and F. It can also be appreciated that steps F and A can be coordinated to have the next user 50 ready to be loaded as the next motion platform 16 moves from the health check station 41b to the load station 41c.

FIG. 3 illustrates a generic three dimensional representation of the motion platform 16 with a user 50 on, within, or otherwise interfaced with the motion platform 16, to illustrate that the motion platform 16 can be configured in a number of ways to deliver various types of simultaneous virtual and physical experiences. For example, the motion platform 16 can be configured as a kart or vehicle, a mobile chair, body armor or suit, weaponry, harness (e.g., for ziplining, skydiving or bungee jumping), sporting equipment, etc. The user 50 is coupled to or otherwise interacts with the motion platform 16 to experience at least one form of haptic feedback, including movement, vibrations, impacts and other sensory-inducing stimuli to blend with a virtual experience being felt through use of a VR headset 52. As shown in FIG. 3, the motion platform 16 can translate along a plane provided by a ground-engaging surface such as the flooring in the arena 14.

FIGS. 4, 5 and 6 illustrate various other movements that can be made by the motion platform 16 in addition to the ability to translate (e.g., drive) over a surface. In FIG. 4, the motion platform 16 can tilt both forward and backwards as discussed above, to stimulate a sense of climbing or descending along a path. As shown in FIG. 5, the motion platform 16 can also experience yaw movements, which can include basic steering around a curved path to rotary movements on the spot like a tank or lawnmower. While not shown in FIG. 5, the same principles can be applied to a motion platform 16 capable of providing roll movements in order to simulate pitch, roll, yaw, and heave, in addition to translations along two axes.

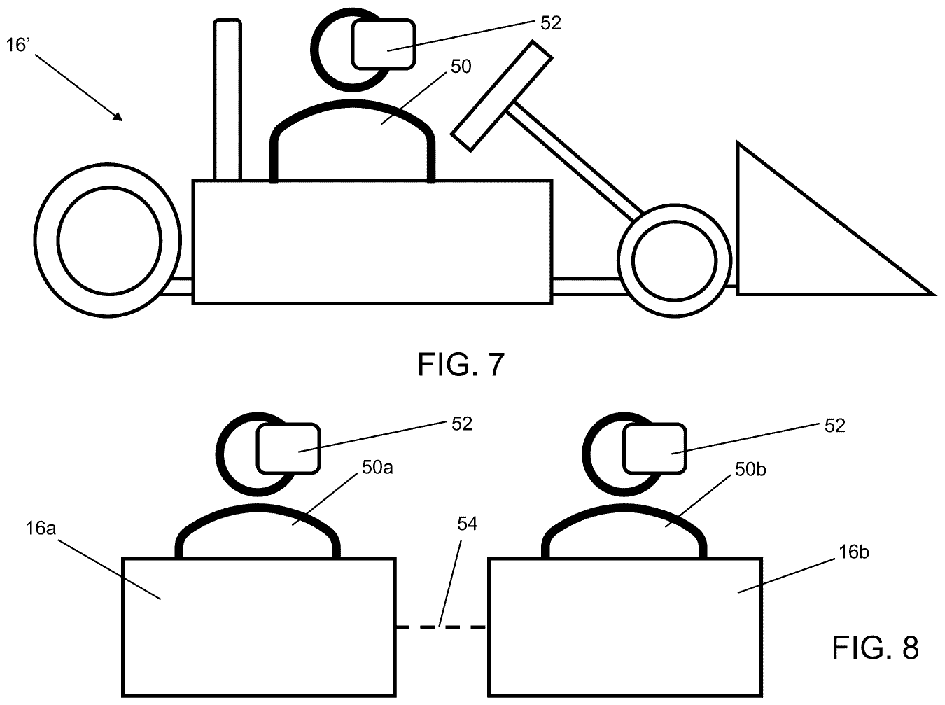

FIG. 6 illustrates that a motion platform 16 can also allow multiple independent movements. For example, a single physical motion platform 16 can include “seats” for more than one user with one user capable of yaw movements independent of driving movements performed by the other user to drive a kart, tank, aircraft, boat, etc. This permits various shared experiences such as being in battle or racing together on a team. The multi-person motion platform 16 can also be rendered virtually such that two (or more) users in two (or more) different physical motion platforms 16 are rendered together in the virtual world to enable such a shared experience without requiring a more complex motion platform 16 and/or without requiring the users to be located physically next to each other or even in the same arena 14.

FIG. 7 illustrates an example of a motion platform 16 that is configured as a go-kart or racing vehicle in which a user 50 equipped with a VR headset 52 can ride the vehicle 16′ within the arena 14 while experiencing the track, environment, and other racers in the virtual world. It can be appreciated that the form shown in FIG. 7 is purely illustrative and can be adapted to differently sized vehicles that accommodate different sub-systems such as drive systems (e.g., number of motion units or wheels), seating configurations, steering wheel/yoke configurations, and onboard space for batteries and control systems. FIG. 8 illustrates a pair of users 50 in a pair of coupled motion platforms 16a, 16b, with the coupling 54 between users being either physical (e.g., a two-seater motion platform 16a/16b) or virtual (e.g., a virtually rendered dual seat vehicle pieced from separate motion platforms 16a, 16b).

An example architecture for the motion platform 16 is shown in FIG. 9a. In this example, the motion platform 16 includes a servo steering mechanism 56, which can provide manual control, autonomous control, or both. The servo steering mechanism 56 can be adapted for or replaced with any steering mechanism 56 suitable for the steering type uses, e.g., swerve, omni-directional, etc. as discussed above. The motion platform 16 is powered by a rechargeable battery 62 (or battery pack) that can be recharged using a suitable charger 64. The battery 62 provides power to a throttle/brake control 66, a steering control 68 and permits connectivity with the local (on-site) arena server 20. The battery 62 also powers an onboard CPU 70 and an electric power controller 84. The electric power controller 84 is used to drive one or more electric motors 86 to provide motive power to the motion platform 16.

The onboard CPU 70 (which could also or instead be in the VR headset 52) is coupled to an inertial measurement unit (IMU) 72 that has access to various sensors, for example, an accelerometer 74, gyroscope 76, magnetometer 78, a time of flight (ToF) camera 80, an UWB tag 48. The onboard CPU 70 also connects to both a VR-enabled steering module 88 and an autonomous ride mode module 90. The onboard CPU 70 can also connect to the VR headset 52 to coordinate experience data (e.g., game data) that affects both the physical experience (via the motion platform 16) and the virtual experience (within the VR headset 52).

Various optional features of the overall system will now be provided. Where appropriate, the motion platform 16 can be or include a vehicle. The vehicle in this case is the actual physical vehicle (e.g., kart) that the players sit in. The vehicle can have one or two seats, some controls, one or more motors for propulsion, power supply, safety systems, a vehicle control system and a VR headset 52 for each passenger.

The motion platform 16 can be run by hot-swappable rechargeable batteries 62, e.g., lithium batteries or more traditional lead-acid batteries that are typically used in go-karts. The vehicle can be designed to have space for additional batteries 62 to allow for an expansion of equipment and computing power required to drive the VR experience. The motion platform 16 can also be configured to include a number of individual swappable sub-systems to remove complexity and reduce the time associated with repairing motion platform s 16 on-site. FIG. 9b illustrates a schematic example of a motion platform 16 with a number of such swappable sub-systems. Examples shown include, without limitation, modular drive sub-systems 150, which can be removed individually from the motion platform 16. In this way, if a tire or wheel fails, the motion platform 16 can be put back online quickly without requiring a skilled technician or mechanic, by having extra drive sub-systems 150 available on site for easy swapping. Similarly, hot-swappable battery units 152 are shown (four in this example for illustrative purposes), which can be removed quickly on-site as noted above. Other sub-systems that are possible due to the “everything-by-wire” design, include those systems that translate a physical input (e.g., from a user) to an electrical signal that is fed into the VCS or other system. For example, a pedal sub-system 154 can be modularized to allow for repairs as well as different swappable configurations to be made on-site, e.g., to switch from single pedal to multi-pedal motion platforms 16. Similarly, a steering sub-system 156 allows the motion platforms 16 to utilize different steering systems (e.g., aircraft versus race car) while at the same time allowing for failure replacements in real-time. A seat system 158 can also be swappable to allow for different sizes and control options to be changed or failed seats to be replaced. A control sub-system 160 is also shown, which illustrates that other modularized portions of the overall architecture can be made swappable for ease of changeover and repair. Various other sub-systems 162 can also be modularized as needed, depending on the type of experience, application, motion platform 16, user, arena 14, etc. It can be appreciated that any consumable or wearable part or sub-system can be modularized as illustrated in FIG. 9b. Moreover, these sub-systems can be serialized and tracked at the arena 14 and within a wider inventory system such that the consumed or broken sub-systems are sent off-site for repair. Such serialization and tracking can also be used to track the number of faults in different configurations, settings, or venues, to enable other actions to be taken, e.g., to correct employee behaviors or detect defects. Automated tracking can also enable sites to automatically order new parts as they are consumed and detected on-site.

Returning to FIG. 9a, for propulsion, the propulsion system can use computer-controlled brushless DC motors (BLDC) as the electric motors 86 and the vehicle can utilize one, two or four motors. For example, a single-motor rear-wheel drive can be provided with a steering servo that controls the direction of the two front wheels. This is also similar to how most traditional go-karts work. Having two independently powered wheels can provide more flexibility, easier control, and the ability to do things like turning in place. Having four independently powered wheels provides even greater control, e.g., swerve-type control, possibly using multi- or omni-directional wheels each using one or multiple motors. Additional wheels (e.g., for a total of 6 or 8 wheels) can also be implemented. In the two-and four-wheeled cases hub motors (similar full-scale electric cars) could also be utilized. The physical throttle/braking system 66 can also be computer controlled in this example architecture.

The steering mechanism 68 can include force feedback so the user knows when the system 10 is steering for them, an accelerator, a brake and some sort of switch or lever for changing directions (i.e., forward and reverse). These elements can be provided by the throttle/brake module 66 in connection with the steering module 68.

The motion platform 16 receives commands from the onboard CPU 70, such as steering/speed limits to prevent collisions, specific steering/speed settings when auto driving, limits set to 0 when game is stopped (kart initializes in this state), if no limits, and no specific settings, local inputs (pedals and steering wheel) control movement; if no input for 2 seconds, assume arena server 20 has crashed, and set all limits to 0 (i.e., stop kart). For example, if no inputs are registered and shared from the onboard CPU 70 to the arena server 20, the arena server 20 can command all onboard CPUs 70 to shutdown as it assumes a fault. No knowledge of the location of other motion platforms 16, and no complicated logic would therefore be required to avoid collisions, since this is handled centrally.

An example vehicle design can use a steering wheel, an accelerator pedal, a brake pedal and a fwd/rev switch (e.g., mounted on the steering wheel). This can vary based on the experience (e.g., game), arena 14, motion platform 16, etc., and can be made modular (e.g., swap the steering wheel for a joystick or a flight yoke or a rudder control lever). These variations can be made without impacting the software, since the same four basic inputs are the same (steering, acceleration, brake, direction). In addition, there can be various switches and buttons. For example, there might be a switch for turning the (virtual) lights on and off, a button for the (virtual) horn, controls for the radio (which plays spatialized audio in the virtual environment), etc. For safety reasons, a “deadman's chair” and seat belt lock can also be implemented.

The on-board vehicle control system (i.e., the complete system of controllers/microcontrollers on-board the motion platform 16 and separate from the headset 52) takes input from the user controls and uses it to drive the propulsion system (i.e., drive-by-wire). The main controller can, by way of example only, be an ESP32 which communicates with other system components using, for example, I²C. A separate motor control processor (e.g., ATmega328) that uses one pulse-width modulation (PWM) output to control the steering servo 56 and another PWM output to control the electronic power controller 84 that drives the electric motor 86. By default, the vehicle control system can read the steering input and apply it to the steering servo 56, and read the (accelerator, brake, direction) inputs and apply them to the electric motor 86. The brake can be made to take precedence over the accelerator, so if the brake is pressed the accelerator input is set to zero. The brake input can also be applied to the mechanical brake once engine braking becomes ineffective. Additionally, the ESP32 (or equivalent controller) can receive messages from the global server 22 to partially or completely override the player's control. The ESP32 (or equivalent controller) can also send status messages to the global server 22. The ESP32 (or equivalent controller) can also read the IMU 72 to determine which direction the vehicle is facing (i.e., yaw) but can also be capable of sensing pitch and roll (which may be useful in case of unforeseen circumstances).

The vehicle control system ecosystem can have a removable EEPROM containing parameters such as vehicle number (but see more below), motor parameters, friction coefficient, hardware version, WiFi connection details, central server IP address, logs, etc.

The steering, accelerator and brake inputs are connected to the ADC on another ATmega328, and the direction switch is connected to a digital input. Other binary inputs (lights, horn, etc.) can also be connected to the ATmega328 In one example, the ATmega328 sends all these inputs to the ESP32 over I²C.

A tracking system 47 (e.g., time of flight sensor, lidar, etc.), including either front and back mounted sensors or a rotating 360 degree sensor mounted on a mast can also be used as discussed above.

The ESP32 (or equivalent controller) can also run a small web server that displays the vehicle state and allows forcing of outputs. It can also allow changing of parameters and activation of ground lights to identify the vehicle.

Several independent safety systems can be used that are designed to keep the players as safe as possible. The arena server 20 can send a message to a vehicle control system (VCS) to stop the vehicle as quickly as possible in a safe manner. The VCS as described herein may include any one or more components used in controlling the MP 16, e.g., the components and system design shown in FIG. 9. The arena server 20 can also send “heartbeat” messages at regular intervals. If the VCS does not receive a message from the arena server 20 within a certain interval, it stops the vehicle quickly. There can also be a sensor in each seat that detects when a player has left the vehicle. If this sensor is triggered, the VCS stops the vehicle quickly. There can also be a sensor in each player's safety harness. If the player removes their harness, the VCS stops the vehicle quickly. Temperature, current and voltage-level sensors can be used in the battery 62 such that if the values are out of range, the VCS cuts power immediately. Similarly, if the lidar system 47 detects anything getting too close, the VCS stops the vehicle quickly. A separate “Sentinel” (e.g., another ATmega328) can also be used to communicate with the other components over I²C. If it doesn't hear from all of them on a regular basis, it completely cuts power to the vehicle after applying the brakes and notifying the arena server 20.

Referring again to FIGS. 2a and 2b for reference, the arena 14 can also incorporate an “invisible fence” around the perimeter of the arena 14 to provide a mechanical/physical safety system in addition to the software safety systems described herein. A sensor in the motion platform 16 can be configured to apply the brakes and cut power if the motion platform 16 crosses that fence and not allow the power to be re-applied until the vehicle is physically moved away from the fence. This fence system can be deployed independent of other sub-systems within the overall system 10.

The motion platform 16 may also have linear actuators to provide the tilting effect shown in FIG. 4 when the vehicle goes up or down a (virtual) incline. The seats may also have vibration motors to provide haptic feedback (like going over a rough road). These are all controlled by the vehicle control system, using information from the VR headset 52.

The arena server 20 can be made responsible for the following:
monitoring the health and status of all the vehicles.
receiving vehicle position data from tracking system, and mapping tag ids 48 to vehicle ids.
taking over guidance of the vehicles as needed to prevent them from colliding with each other or the physical walls of the arena.
taking over guidance of the vehicles at the end of a game to return them to their home positions.
bridging traffic between different arenas for large-scale gameplay.
providing a simple operator control system (big buttons for start, stop and reset).
providing alerts when something unexpected happens (player leaves vehicle, vehicle stops for any reason, etc.)
monitoring arena sensors (door open, etc.) and stopping games as needed.
running a web server that displays a game control console with a tab for each game.
providing a webservice to map a vehicle number to a game ID and a pair of player IDs.
providing a webservice to map a game ID to a list of vehicle numbers in that game.
broadcasting the current location, rotation and movement vector of all the vehicles.

There are two approaches to the VR aspect of the system 10, namely a standalone VR headset 52 or a conventional VR headset 52 powered by a small computer (e.g., an NUC). The NUC can provide better graphics and higher frame rates and may be used for higher end games and headsets 52. Different arenas 14 can make different choices based on the content they want to offer. Regardless, the MPs 16 can be designed with a bay large enough to hold a full-sized NUC. A two-passenger MP 16 can also be sized to have space for two NUCs.

Communication between the VR headset 52 and the VCS is described below. Communication between the VCS and the arena server 20 can be done using user datagram protocol (UDP), for performance and simplicity. The data sent (broadcast or multicast) from the VCS can include: protocol version (unsigned byte) format, vehicle number (unsigned byte), yaw angle (float), speed (float), accelerator input (float, normalized to range 0 to 1), brake input (float, normalized to range 0 to 1), steering input (float, normalized to −1 to +1 range, with −1 being hard left), steer front (float), direction (signed byte, 1 for forward, −1 for reverse, 0 for park), seat angle (floating point), IMU readings (9 floats—gyro, acc, mag), battery voltage (unsigned byte), digital sensors (seat switch, harness switch), LIDAR readings (array of floating point distance values, one for each angle (in degrees)), motion platform position in arena (floating point x, y, z) if available from a UWB tag, and firmware version number (unsigned 32-bit integer).

The data sent (unicast) from the arena server 20 or the VR headset 52 to the VCS can include protocol version (unsigned byte), control mode (unsigned byte), parameters (array of floats). The control mode can be one of the following constants: ALL_STOP—engine speed set to zero, full braking applied; DRIVE_MODE—steering and engine speed are controlled by the player; RANGE_LIMITS—Central Server sets limits on player control; four floating point parameters give min/max steering limits and speed limits; RIDE_MODE—VR system controls the vehicle; two floating point parameters give current steering and speed (each −1 to +1); and one floating point parameter giving the angle of the seat (for the linear actuator).

The vehicle location information sent (broadcast) by the arena server 20 can include: protocol version (unsigned byte), number of vehicles (unsigned byte), and array (one element per vehicle) of: vehicle number (unsigned byte), position (floating point x, y, z), trajectory (floating point x, y, z), and rotation (floating point).

These vehicle location messages can be sent to remote arenas 14. In this example, by using UDP broadcast from vehicles to the server 20, the server address does not need to be known. If running multiple games in the same arena, UDP multicast can be used, where each game has a different multicast address. The VR headsets 52 can get the information about all the vehicles as well, including its own, by listening to the UDP broadcasts (or multicasts). UDP unicast can be used directly to each vehicle from either the arena server 20 or from the VR headset 52 for control functionality.

RANGE_LIMITS can take precedence over RIDE_MODE and DRIVE_MODE for safety reasons. If a RANGE_LIMITS message has been received in the last few seconds, attempts to set other modes would be ignored in such a configuration.

The vehicle number can be read from an 8-bit DIP switch on the board, which is set to the vehicle number painted on the side of the vehicle (so boards can easily be swapped around as needed). The vehicle number can also be used as the bottom 8 bits of the static IP address of the vehicle, to avoid having to worry about DHCP. The VR headset 52 can also be configured with the vehicle number, possibly through a one-time pairing process, e.g., by putting the game into a pairing mode and tapping the brake pedal of the vehicle you are pairing the headset with.

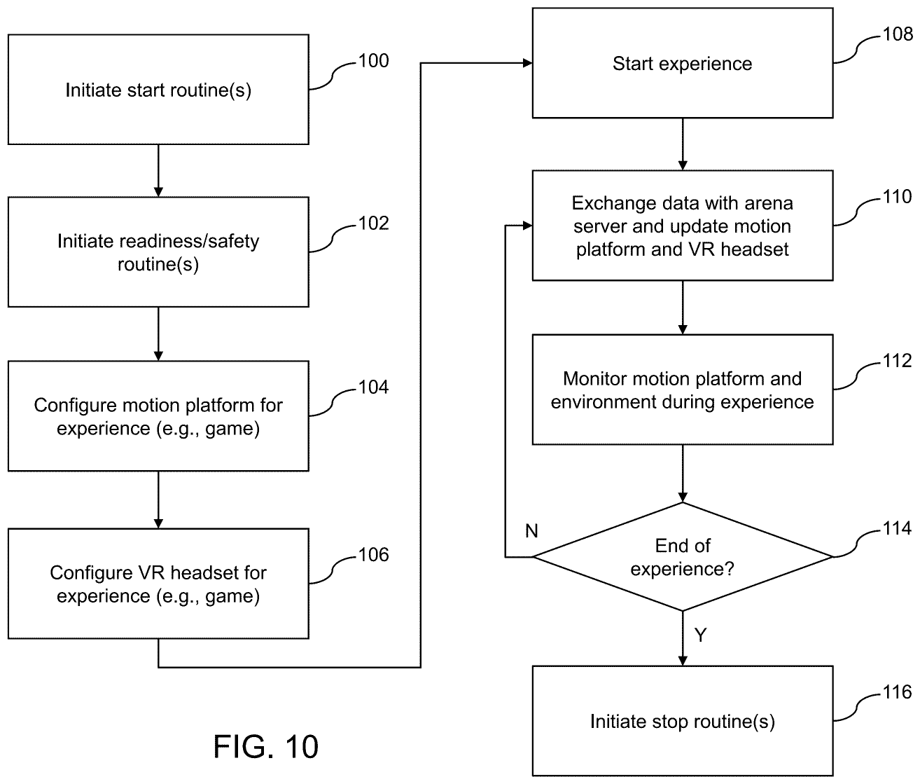

Referring now to FIG. 10, a flow chart is provided which illustrates operations performed by the motion platform 16 in communicating with the arena server 20 to initialize and participate in an experience. At step 100 the motion platform 16 establishes a connection with the arena server 20 in order to initiate any required start routines, such as to begin loading experience data, including skins for the motion platform 16 that will be seen in the virtual world, driving modes (e.g., driver vs. autonomous modes), audience interactivity, payment details, etc. At step 102 the arena server 20 and the motion platform 16 can communicate with each other to execute any required readiness/safety routines, including driver safety harnesses, environment scanning for required spacing or obstacle avoidance, arena readiness protocols, etc. The motion platform 16 may also need to configure itself for the experience at step 104, which can include initiating renderings in the virtual world to align that user 50 with other users 50, either in their motion platform 16 or another motion platform 16 in the arena or elsewhere. Similarly, other participants in the experience should be configured in their respective motion platforms 16 to align their perspective. At step 106, the motion platform 16 can sync with the VR headset 52 of the user 50 to map the virtual world to the motion platform(s) 16 participating in the experience to create the simultaneous physical and virtual experience described above.

At step 108, the motion platform 16 detects that the experience is starting and launches into an experience execution routine illustrated by steps 110-114. At step 110, the motion platform 16 exchanges data with the arena server 20 to continually update both the motion platform 16 and the VR headset 52 to account for events and progressions within the experience. For example, the onboard CPU 70 can be configured to sample the IMU 72 and then “course correct” using the tracking system (e.g., UWB) through, for example, a Kalman filter. The onboard CPU 70 can receive other players' physical positions and leaderboard so Player A can know where Player B is located. Based on the onboard CPU 70 situational awareness of location, it can either allow or deny a user's input to the system and completely override it if necessary. In one scenario, the UWB anchors 46 can communicate to the arena server 20 the location of tag 48, which it will pass on to the onboard CPU 70. The arena server 20 “controls” the game mostly from a safety perspective, if it loses a heartbeat from any motion platform 16, the game stops. Also, if a user leaves the motion platform 16 the game stops, etc. At step 112, the motion platform 16 can also utilize its onboard monitoring systems 47 such as time-of-flight or lidar to monitor itself and the surrounding environment during execution of the experience. This can be done, for example, to trigger alerts if the motion platform 16 hits the invisible fence or an obstruction 44 as illustrated in FIG. 2. It can be appreciated that steps 110 and 112 are shown using two steps for illustrative purposes only and these steps could be executed in any one or more steps, routines or protocols according to the nature of the motion platform 16 and the experience being enjoyed. These steps can also vary based on the nature of the arena 14 in which the experience is being executed. At step 114 the motion platform 16 determines if the experience has ended (e.g., check for an end of experience command). If not, the steps 110-114 are repeated so as to continually exchange data with the arena server 20 and execute any monitoring or onboard operations throughout the experience. At step 116, after having detected the end of the experience, the motion platform 16 can initiate any stop routines, such as coming to a stop physically and rendering appropriate end of experience content through the VR headset 52.

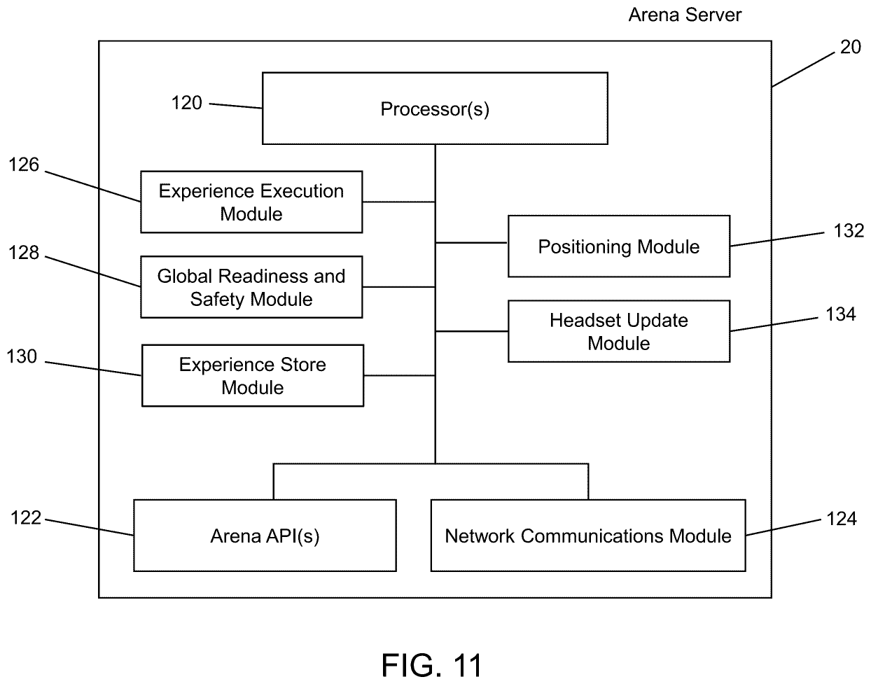

In FIG. 11, an example configuration for the arena server 20 is shown. In certain embodiments, the arena server 20 may include one or more processors 120, one or more arena APIs 122 to communicate with entities, modules and/or systems within the arena 14, and a network communications module 124 for interfacing with networks such as the Internet to communicate with the arena 14/motion platforms 16 and the global server 22. The arena server 20 can be embodied as one or more server devices and/or other computing device(s) configured to operate within the system 10. Communications module 124 enables the arena server 20 to communicate with one or more other components of computing environments associated with the system 10, such as the arena 14, the motion platforms 16, and the global server 22, via a bus or other communication network. While not delineated in FIG. 11, the arena server 20 includes at least one memory or memory device that can include a tangible and non-transitory computer-readable medium having stored therein computer programs, sets of instructions, code, or data to be executed by processor 120. FIG. 11 illustrates examples of modules, tools and engines stored in memory on the arena server 20 and operated by the processor 120. It can be appreciated that any of the modules, tools, and engines shown in FIG. 11 may also be hosted externally and be available to the arena server 20, e.g., via the communications module 124. In the example embodiment shown in FIG. 11, the arena server 20 includes an experience execution module 126, a global readiness and safety module 128, an experience store module 130, a positioning module 132, and a headset update module 134.

The experience execution module 126 can be used to communicate with the global server 22 to obtain the appropriate experience data for the experience being executed at the arena 14 associated with the arena server 20 (e.g., damage levels that can provide player rankings). With readiness and safety checks complete, the experience execution module 126 can launch the experience at the rider level. Using the experience execution module 126, if the arena server 20 detects a safety layer trigger the arena server 20 can send stop commands to the motion platforms 16 it is responsible for. The experience execution module 126 can also be in communication with the global server 22 to initiate start and stop commands under the direction of the global server 22, e.g., for multi-location events.

The global readiness and safety module 128 can be used to coordinate a flow-through of a defined communications protocol used to ensure that everything in the system 10 operating at a particular local experience site 12 is in working order. For example, a motion control unit can be implemented to look for heartbeats from all other local systems on the motion platform 16 and then provide the “all clear” to the arena server 20. That can include items like, seatbelts, weight sensors plus ensuring all electronics are behaving “normally”. If a fault is detected, that fault is noted and mapped to a motion platform ID in order to initiate measures to rectify the fault to begin or resume game play.

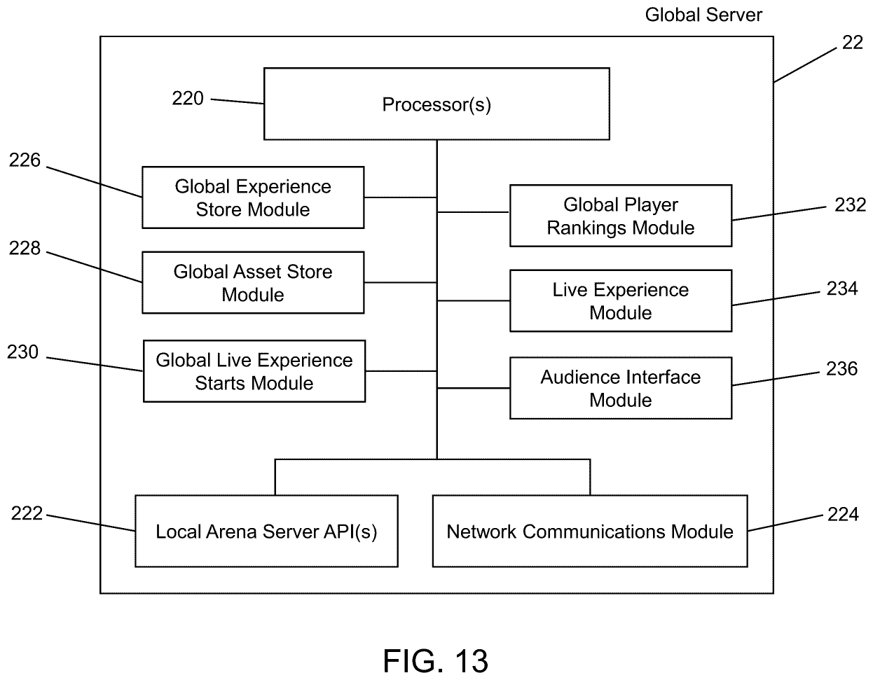

The experience store module 130 can be used to connect into the creator space 24 either directly, or as shown in FIG. 1, via the global server 22 to receive the appropriate experiences for the particular event, arena 14 and motion platforms 16 being used. This connection can also enable digital assets from an economy built on top of the system 10 to be received. For example, if a user loads a skin created by another user and pays a premium for using that skin, the transaction can be triggered through the experience store module 130 and the asset loaded into the virtual environment to be visualized by the user 50 using the VR headset 52. In this way, the experience store module 130 can provide an interface with the creator space 24, audience environment 26, and PoS system 28 via the global server 22 in order to render customized real-time simultaneous physical and virtual experiences as discussed above. This can be done by communicating with a global experience store module 226 and/or global asset store module 228 on the global server 22 (see also FIG. 13). These modules are shown separately for ease of illustration and could be combined in other embodiments.

The positioning module 132 can be used to manage in-experience positioning information gathered from the motion platforms 16 while also being able to send data to the motion platforms 16, e.g., to control autonomous driving or to reposition the motion platform 16, either to override the user 50 or to augment manual driving. The positioning module 132 can also be used to layer on virtual damage by detecting when a collision occurs in the virtual world and based on the positioning of the motion platforms 16 determine which ones should have virtual damage and/or to render a crash. The positioning module 132 can therefore be used both to track and control the positioning of the motion platforms 16 and detect and render virtual damage or other contact that can trigger haptics for the user to simulate a physical world crash within that virtual environment.

The headset update module 134 is used to correlate or map any positioning (e.g., race placement) and virtual damage (e.g., artillery hits) to player points, rankings, leaderboard and other competitive aspects of the game. This can be done by exchanging information between the motion platforms 16 and the arena server 20 to determine what is happening in the arena 14 for a specific user 50 relative to other users 50 in the game, whether they are in the same arena 14 or at another local gaming site 12. The motion platforms 16 and the arena server 20 thus exchange information to determine its own leaderboard locally and publishes this information to the global server 22, which can sort out any global rankings or leaderboards. The headset updates can also be used to render anything in the virtual environment that should be experienced by the user 50 during the experience, via their VR headset 52. This can include game/race data, the introduction or removal of contextual or background elements, the introduction of digital assets, either purchased or consumed by the user 50 or by audience members, etc.

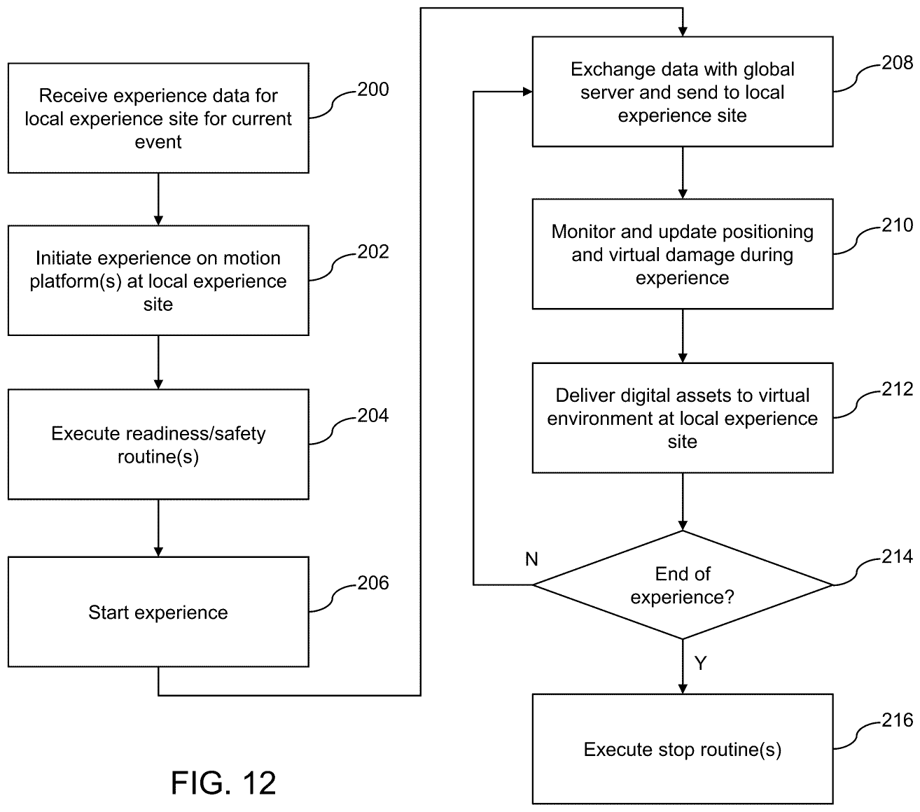

Referring now to FIG. 12, a flow chart is provided which illustrates operations performed by the arena server 20 in communicating with the motion platforms 16 and global server 22 to initialize and participate in an experience. At step 200, the arena server 20 receives the experience data for its local experience site 12 from the global server 22, for a current experience event. For example, if an event is scheduled for 7:00 pm on a Wednesday, the arena server 20 may receive or request the experience data for that event from the global server 22 prior to the event beginning. This can be coordinated through a calendaring or booking system and can enforce certain cutoff times for players to customize vehicle and tracks and to purchase digital assets like ammunition or speed boosters. At step 202, the arena server 20 initiates the experience on the motion platforms 202 participating at the local experience site 12 and may coordinate with the global server 22 to blend in offsite motion platforms 16 in the virtual environment. At step 204, the arena server 20 executes the readiness and safety routines discussed above. The experience may then be started by the arena server 20 at step 206, which can be controlled directly by the arena server 20 or be controlled by the global server 22.

When the game begins, the arena server 20 can enter a loop that executes steps 208-212 until the end of the game is detected at step 214. At step 208, the arena server 20 exchanges game and other data with the global server 22 and sends the appropriate data to the local experience site 12, e.g., by communicating with the motion platforms 16, attendants 18, etc. During the experience being enjoyed, the arena server 20 also monitors and updates the positioning and virtual damage events at step 210, such that events that occur at or between certain motion platforms 16 are offset or intersect at the appropriate location in the virtual world while ensuring that the motion platforms 16 trigger the corresponding haptic feedback, e.g., to simulate climbing a hill, colliding with another player, engaging in combat (including firing ammunition), etc. It can be appreciated that either or both steps 208 and 210 can include any safety stoppages or shut down modes required based on feedback from the local gaming experience site 12 or the global server 22. At step 212, the arena server 20 is also responsible for delivering digital assets to the virtual environment at the local experience site 12, e.g., to change or update the environment or track, deliver new ammunition or speed boosters to the user, or any other digital asset that can be updated, added or controlled in real time during the experience, either as dictated by the global server 22, the audience members, or the players themselves, both in the local experience site 12 and elsewhere. When the end of the experience is detected at step 214, the arena server 20 can execute stop routines at step 216, similar to those discussed above with respect to the motion platforms 16 in FIG. 10.

In FIG. 13, an example configuration for the global server 22 is shown. In certain embodiments, the global server 22 may include one or more processors 220, one or more arena server APIs 222 to communicate with the arena server(s) 20, and a network communications module 224 for interfacing with networks such as the Internet to communicate with the arena server 20 as well as the other connected entities shown in FIG. 1, including the creator space 24, audience environment 26, and PoS system(s) 28. The global server 22 can be embodied as one or more server devices and/or other computing device(s) configured to operate within the system 10. Communications module 224 enables the global server 22 to communicate with one or more other components of computing environments associated with the system 10, such as the arena 14 and the motion platforms 16, via the arena server(s) 20, via a bus or other communication network. While not delineated in FIG. 13, the global server 22 includes at least one memory or memory device that can include a tangible and non-transitory computer-readable medium having stored therein computer programs, sets of instructions, code, or data to be executed by processor 220. FIG. 13 illustrates examples of modules, tools and engines stored in memory on the global server 22 and operated by the processor 220. It can be appreciated that any of the modules, tools, and engines shown in FIG. 13 may also be hosted externally and be available to the global server 22, e.g., via the communications module 224. In the example embodiment shown in FIG. 13, the global server 22 includes a global experience store module 226, a global asset store module 228, a global live experience starts module 230, a global player rankings module 232, a live experience module 234, and an audience interface module 236.

The global experience store module 226 can interface with the creator space 24 to receive experiences and digital assets created by users 50 or audience members to be used in certain experiences. This can include customized tracks or skins for anything in the virtual environment, as well as weaponry, boosters (e.g., speed, strength, size), costumes/outfits, etc. A separate global asset store module 228 can be provided as shown in FIG. 13 or as part of the global experience store module 226.

The global live experience starts module 230 is used to coordinate and initiate experience sat the arena servers 20 to be delivered to the local experience sites 12 (e.g., for a multi-venue synchronous launch), which can include deploying standalone experiences at a particular experience site 12 or by coordinating multiple different locations.

The global player rankings module 232 is used to coordinate player rankings and positions within an experience to update leaderboards and deploy updates to the arena server(s) 20 to be updated at the motion platforms 16 at each local experience site 12. The global player rankings module 232 can also interface with the audience environment 26 to update the leaderboard as gameplay progresses.

The live experience module 234 is used to allow for audience participation for a given live event whereby if an audience member has purchased a prescribed in-experience asset, they will be able to deploy it during live execution of the experience (e.g., during game play). For example, a first person shooter game is currently live and an audience member purchased ammo, they can choose to drop the ammo near their favorite player to help them reload. This can be implemented using a web browser extension and can be configured to communicate with the other modules described herein.

The audience interface module 236 provides an API or other connection into the audience environment 26 as well as the PoS system(s) 28 and/or creator space 24 that may be used by audience members to interact with the live events.

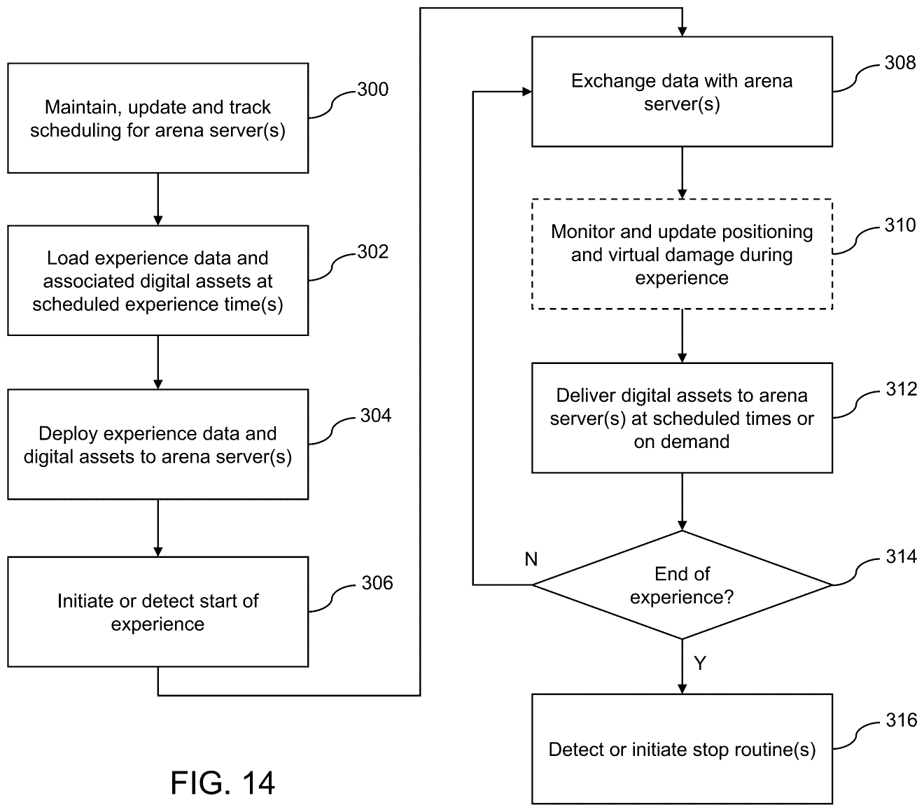

Referring now to FIG. 14, a flow chart is provided which illustrates operations performed by the global server 22 in communicating with the arena server(s) 20 to initialize and participate in an experience. At step 300, the global server 22 can be responsible for maintaining, updating and tracking scheduling for experiences to be deployed and executed by the arena servers 20. For example, this scheduling can include bookings and payments and coordination between multiple local experience sites 12 or individual experience sites 12. At step 302, the global server 22 loads experience data and any associated digital assets at scheduled experience times. For example, a booking can include which players are registered to enjoy the experience (e.g., play a game) using a particular motion platform 16 and any digital assets such as tracks or skins that have been pre-allocated or pre-purchased can be queued up for deployment at the arena 14 in time for a live event. This enables the global server 22 to monitor and coordinate the alignment of the physical and virtual worlds associated with the live events to provide the simultaneous physical and virtual experiences described herein.

At step 304 the global server 22 can deploy the experience data and digital assets for a booking to the corresponding one or more arena servers 20. This enables the arena server(s) 20 to initiate the experience at their end, which would be detected by the global server 22 at step 306, or the initiation of the experience start can be controlled directly from the global server 22. When the experience has started, an execution loop in steps 308-314 can commence to enable the global server 22 to participate, where needed, in coordinating the live events at one or more local experience sites 12.

In step 308, the global server 22 exchanges data with the arena server(s) 20 in order to provide approved and registered experience content and if there are multiple sites to coordinate an experience. Step 310 can be executed by the global server 22 when a multi-site experience is occurring and the master server 22 is responsible for updating the different arena servers 20 as the experience progresses. Any digital assets can be delivered to the arena server(s) 20 at scheduled times or in real-time or on demand during the experience at step 312, e.g., to allow audience participation or on-the-fly purchases by players as described herein.

When the end of the experience is detected at step 314, the global server 22 can execute stop routines at step 316, similar to those discussed above with respect to the motion platforms 16 in FIG. 10 and the arena server(s) 20 in FIG. 12.

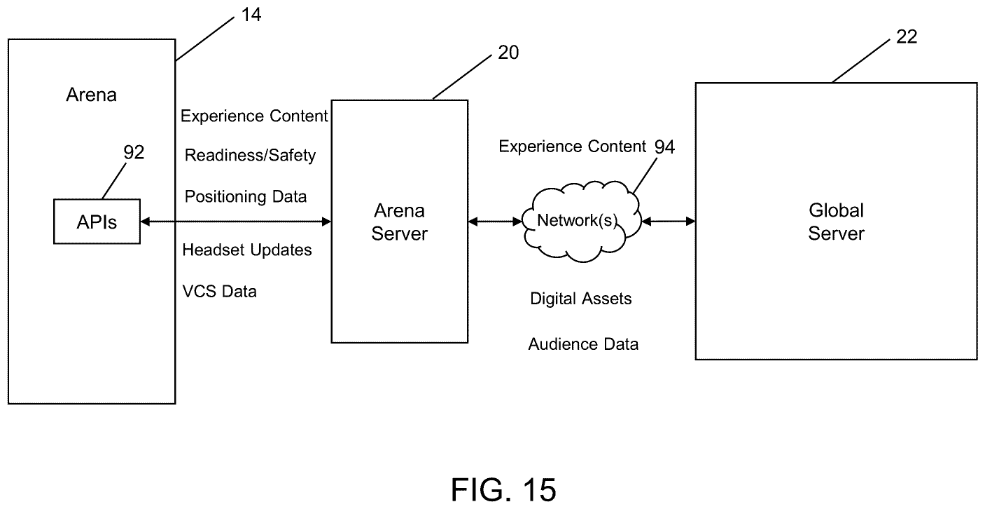

Referring now to FIG. 15, an overview of the arena 14, arena server 20 and global server 22 to illustrate data flows between these entities to summarize the configurations shown in FIGS. 1, 9, 11 and 13. Here it can be seen that the arena server 20 utilizes APIs 92 into the various entities being used at the arena 14 associated with its local experience site 12, for example, APIs 92 into each of the motion platforms 16 as well as into the attendant booth 40 or any other computing device with which it communicates during a live or regular event. The arena server 20 uses such APIs 92 to send and receive content, readiness/safety messages or data, positioning data, headset updates, and vehicle control system data related to interactions with the motion platforms 16. The arena server 20 in this example may communicate with the APIs 92 over direct wired connections or wireless protocols such as WiFi, Bluetooth, etc. As shown in FIG. 15, the arena server 20 communicates with the global server 22 over one or more networks 94, examples of which are provided above. This is on the assumption that the global server 22 is located physically remote from the particular arena server 20 that is shown. This communication connection enables the local and global servers 20, 22 to exchange experience content, digital assets (to be put within the data or headset updates sent to the arena 14), as well as audience data that again can be wrapped into the experience data or headset updates.

While a single arena server 20 is typically sufficient for a local experience site 12, it can be appreciated that multiple arena servers 20 could be used at the same site 12, e.g., to facilitate multiple arenas 14 or to balance loads at larger venues. It can also be appreciated that while FIG. 15 illustrates a single arena server 20 connected to a single global server 22, typically more than one arena server 20 would be controlled by at least one global server 22. Moreover, as with the arena servers 20, multiple global servers 22 can be used to provide regional coverage, load balancing, backups or other business or legal considerations such as content licensing or jurisdictional considerations.

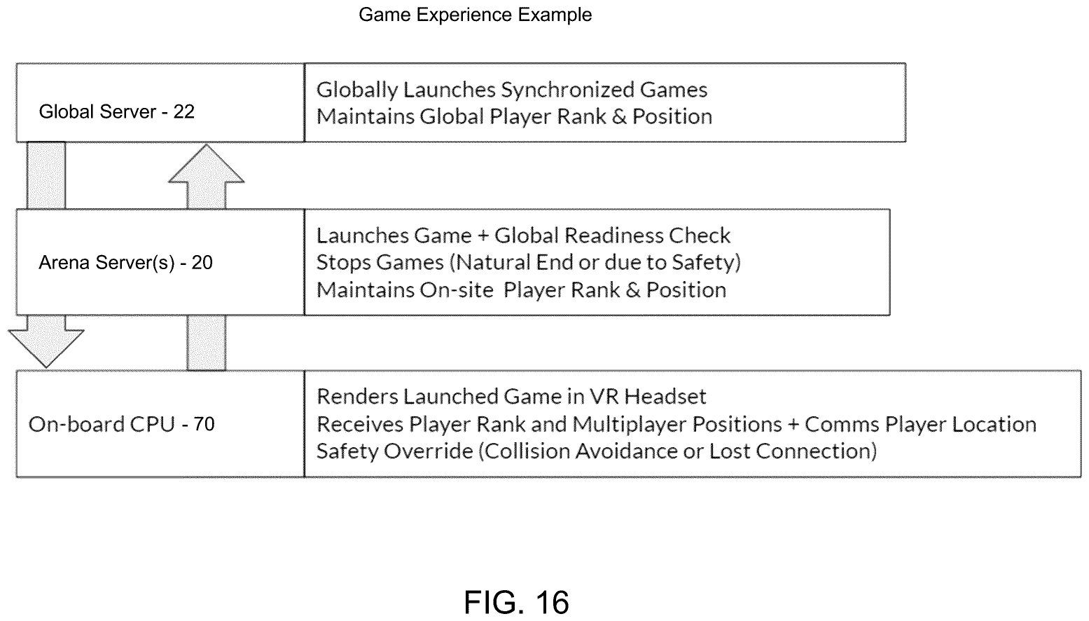

FIG. 16 provides an additional visualization of the communication architecture utilized by the system 10. As illustrated in FIG. 16, the arena server(s) 20 can be used to relay or otherwise hand off certain data and communications between the global server 22 and the on-board CPUs 70 in the motion platforms 16 during an experience. In this example, the global server 22 globally launches synchronized experiences and maintains the global player rank (e.g., 1^{st}, 2^{nd}, etc.) and physical position. The arena server(s) 20 launch the experience and perform the global readiness checks as discussed above, stops the experiences due to their natural end (e.g., number of laps) or due to safety alerts, and maintains on-site player rank and position. That is, while the global server 22 may track a player's overall standings, the arena server 20 can separately track the ranking and position within the actual experience that is occurring during the event at the local experience site 12. The on-board CPU 70 that resides in the motion platform 16 renders the launched experience in the VR headset 52, receives player rank and multi-player positions and locations within the virtual environment, and conducts any safety overrides as discussed herein. This can be done to avoid collisions or to account for lost connections or other scenarios where player safety whether real or virtual needs to be addressed.

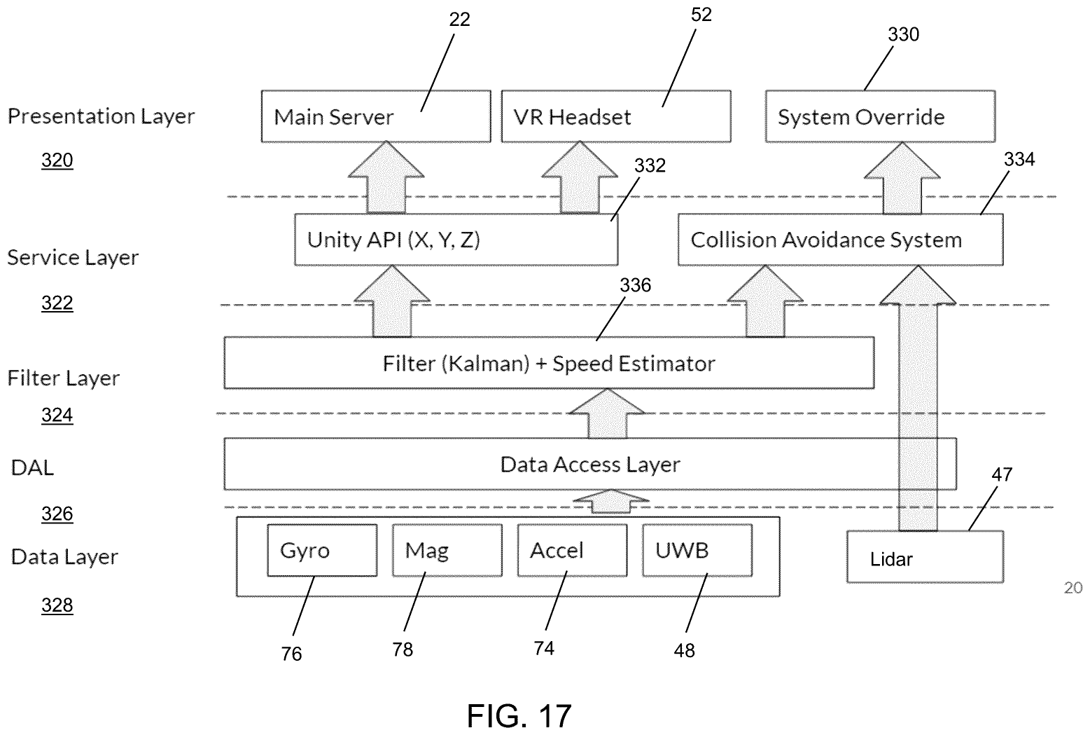

Referring now to FIG. 17, an example of an architecture for localizing motion platforms 16 is shown. The architecture includes a presentation layer 320, a service layer 322, a filter layer 324, a data access layer (DAL) 326, and a data layer 328. The data layer 328 obtains data from the gyroscope 76, magnetometer 78, accelerometer 74, and the UWB tag 48 in this example, as well as any local tracking system 47 such as Lidar, ultrasonic, etc. The data access layer 326 provides an access storage mechanism for the filter layer 324 to access stored data obtained from the data layer 328. In this example, a Kalman filter is provided in the filter layer 324 as well as a speed estimator. The filter and speed estimator 336 provides inputs to a Unity API 332 and a collision avoidance system 334. The collision avoidance system can be implemented as a logic handler responsible for interpreting where every motion platform 16 is and ensure that they are not on a collision course and take appropriate action if they are. For example, a collision course can be either with another motion platform 16 or any other physical object. The collision avoidance system 334 can also receive data from the local tracking system 47 to generate inputs for a system override 330 at the presentation layer 320. The Unity API 332 generates inputs to the arena server 20 and the VR headset 52 at the presentation layer 320. That is, the Unity API 332 can provide the arena server 20 with the location of the motion platform 16, speed etc. so the arena server 20 can appropriately tell the other motion platforms 16 where everyone else is within the virtual world.

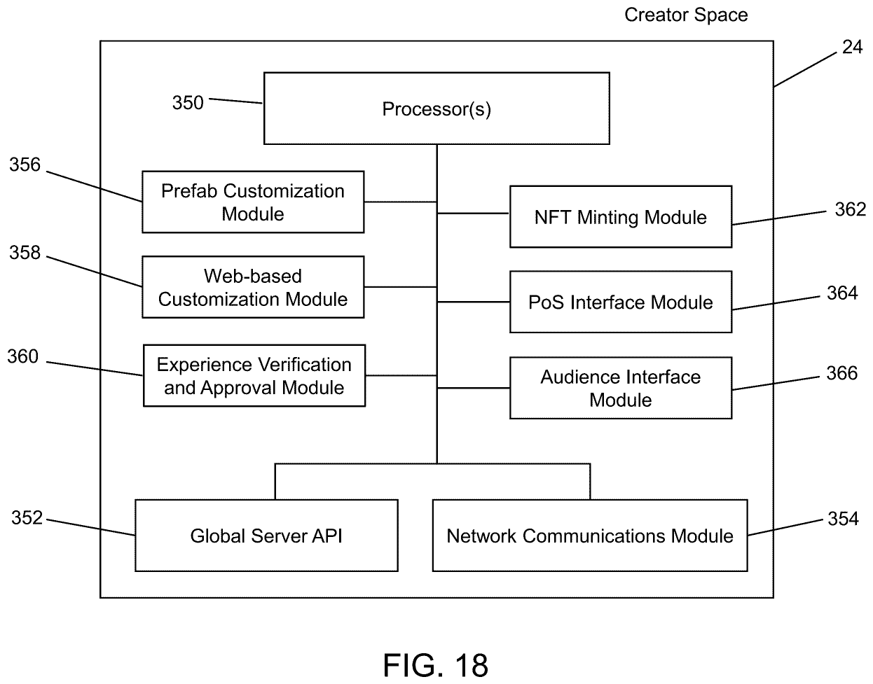

In FIG. 18, an example configuration for the creator space 24 is shown. In certain embodiments, the creator space 24 may include one or more processors 350, a global server API 352 to communicate with the global server 22, and a network communications module 354 for interfacing with networks such as the Internet to communicate with the global server 22 as well as the other connected entities shown in FIG. 1, including the audience environment 26 and PoS system(s) 28. The creator space 24 can be embodied as one or more server devices and/or other computing device(s) configured to operate within the system 10. Communications module 354 enables the creator space 24 to communicate with one or more other components of computing environments associated with the system 10, such as the arena 14 and the motion platforms 16, via the global and arena server(s) 20, 22 via a bus or other communication network.

While not delineated in FIG. 18, the creator space 24 includes at least one memory or memory device that can include a tangible and non-transitory computer-readable medium having stored therein computer programs, sets of instructions, code, or data to be executed by processor 350. FIG. 18 illustrates examples of modules, tools and engines stored in memory on the creator space 24 and operated by the processor 350. It can be appreciated that any of the modules, tools, and engines shown in FIG. 18 may also be hosted externally and be available to the creator space 24, e.g., via the communications module 354. In the example embodiment shown in FIG. 18, the creator space 24 includes a prefab customization module 356, a web-based customization module 358, an experience verification and approval module 360, an NFT minting module 362, a PoS interface module 364, and an audience interface module 366.

The prefab customization module 356 is used to enable the creator space 24 to host or otherwise provide a user interface to permit players 50 or other content creators (e.g., those looking to create and monetize content whether they play a game or not), and/or audience members to create any digital asset in the system 10 from prefab content. For example, the user 50 can use prefab motion platforms 16 for easy customization of colors, logos, shapes, types, branding, weaponry or other features, etc. The prefab customization module 356 can also provide arena prefabs for easy customization of textures, inner spaces, track shapes, etc. Similarly, avatar prefabs can be used to allow users 50 to customize their avatar that will be seen in the virtual world. Other texture prefabs or templates can also be provided to allow for more control over the design and customization processes.

The web-based customization module 358 provides a simplified user interface to enable simpler “codeless” or otherwise plug and play customizations, e.g., for casual players or those without computer development skills. For example, a web page can be hosted that allows players 50 or other content creators (e.g., those looking to create and monetize content whether they enjoy the experience or not) to use drop-down menus or other limited customization option-selecting tools or plugins for more technology friendly creators. It can be appreciated that while shown as separate modules 356, 358 in FIG. 18, the creator space 24 can provide any one or more modules, websites, portals, APIs or other interfaces for content creators of all types and abilities to make customizations or selections from both prefab/template content as well as from scratch.

The experience verification and approval module 360 is used by the content creators to submit created content for an experience for verification. The module 360 can check to ensure that the prefab limits or rules have not been violated, that the content will fit within the parameters of an experience or arena 14, etc. The verification and approval module 360 can also have a utility to communicate with content creators to provide status updates and to indicate when the content has been approved and can be deployed in the system 10.

The NFT minting module 362 is used to enable approved content to be minted as an NFT for personal use or to push the NFT into a community associated with the system 10, e.g., other players that wish to use their customized skin, weapon, track, texture, etc. Further details concerning the economy surrounding this community is provided below.

The PoS interface module 364 enables creators to interface with the economy and any PoS system 38 that is used to pay for or monetize digital assets. This can include providing access to the blockchain 32 to track transactions associated with an asset.

The audience interface module 366 provides an interface into the creator space 24 for audience members, either to create digital assets to supply to players in an event or to create content for monetization whether or not that person is going to participate in an experience.

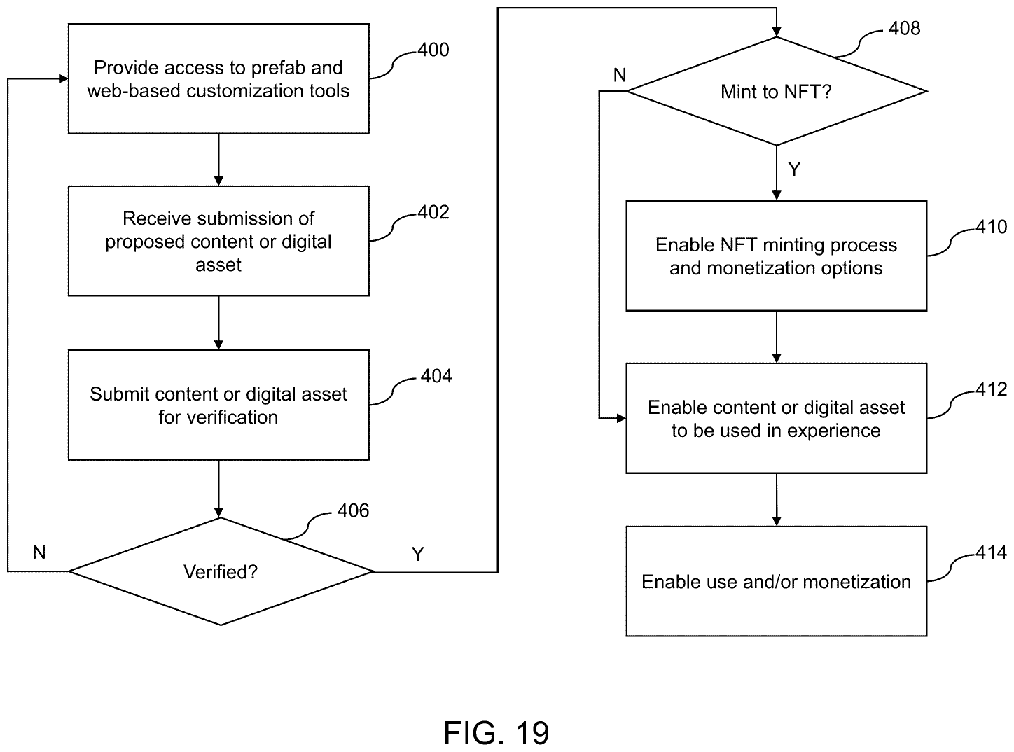

Referring now to FIG. 19, a flow chart is provided which illustrates operations performed by the creator space 24 in communicating with the global server 22, and other entities in the system 10 to permit creation, distribution and monetization of digital assets to be enjoyed during an experience. At step 400, the creator space 24 provides access to the prefab and web-based customization modules 356, 358 to enable registered content creators (which may or may not also be users/players 50) to create their own customizations for a race or venue or to create digital assets that can be used during a specific event or experience (e.g., avatars, weaponry, etc. vs. tracks or live event environments). The content creators would then finalize and submit such content or digital assets, which are received by the creator space 24 at step 402. The creator space 24 uses the verification and approval module 360 at step 404 to submit the content or digital asset for verification and at step 406 to obtain and provide a verification result, such as an approval of the content/asset or a denial. For example, the creator space 34 may determine from the verification and approval module 360 that the proposed colors are not available or the sizing does not fit with a particular arena 14 or track. The verification result can therefore also provide suggested edits to meet certain criteria and can provide a link back into the appropriate customization module 356, 358 to make changes and resubmit.

In this example, assuming that the content or digital asset has been verified, at step 408 the creator space 24 can provide an option to mint the content or digital asset to an NFT. For example, the content creator may create a customized track or vehicle that they wish to monetize through a sale, rental or other licensing arrangement. The creator space 34 utilizes the NFT minting module 362 to enable an NFT minting process and a monetization process 410, which can involve coordination with the PoS system 28 and the blockchain 30 to create a new entry in the digital ledger and to enable tracking of subsequent sales or royalties on rentals and the like. If the content or digital asset is not being minted, step 410 can be skipped. At step 412, the creator space 24 enables the content or digital asset to be used, which can include self-use or distribution to a marketplace to allow others to buy or rent the content or asset. At step 414, the creator space 24 enables the content or digital asset to be used and, if applicable, to be monetized as discussed above.

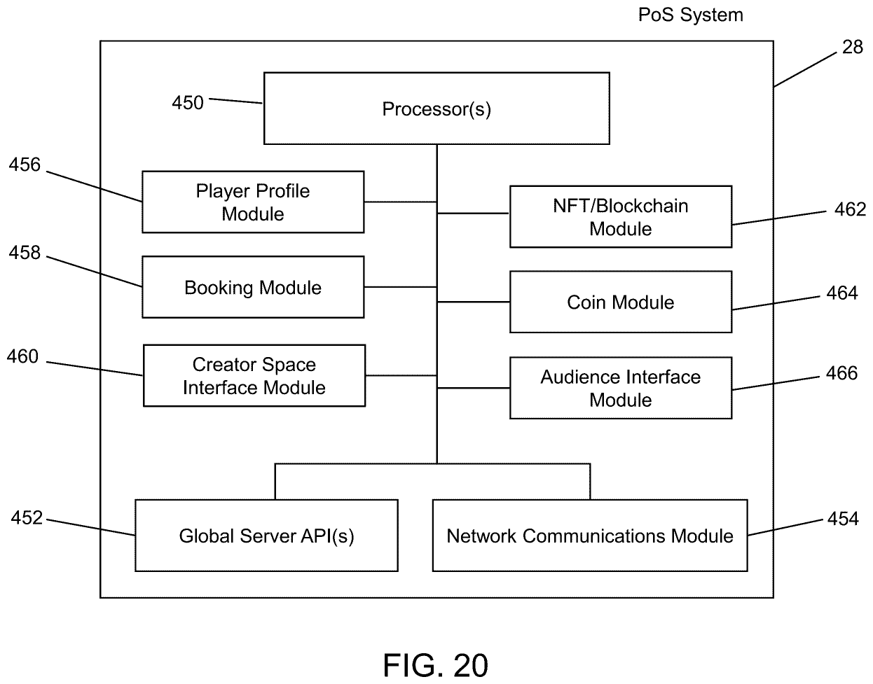

In FIG. 20, an example configuration for the PoS system 28 is shown. In certain embodiments, the PoS system 28 may include one or more processors 450, a global server API 452 to communicate with the global server 22, and a network communications module 454 for interfacing with networks such as the Internet to communicate with the global server 22 as well as the other connected entities shown in FIG. 1, including the audience environment 26 and creator space 24. The PoS system 28 can be embodied as one or more server devices and/or other computing device(s) configured to operate within the system 10. Communications module 454 enables the PoS system 28 to communicate with one or more other components of computing environments associated with the system 10, such as the arena 14 and the motion platforms 16, via the global and arena server(s) 20, 22 via a bus or other communication network. While not delineated in FIG. 20, the PoS system 28 includes at least one memory or memory device that can include a tangible and non-transitory computer-readable medium having stored therein computer programs, sets of instructions, code, or data to be executed by processor 450. FIG. 20 illustrates examples of modules, tools and engines stored in memory on the PoS system 28 and operated by the processor 450. It can be appreciated that any of the modules, tools, and engines shown in FIG. 20 may also be hosted externally and be available to the PoS system 28, e.g., via the communications module 454. In the example embodiment shown in FIG. 20, the PoS system 28 includes a player profile module 456, a booking module 458, a creator space interface module 460, an NFT/blockchain module 462, a coin module 464, and an audience interface module 466.

The player profile module 456 is used to store any relevant information and data related to a player, i.e., users 50 that will participate in an experience. It can be appreciated that the PoS system 28 can also store profile information for content creators or others involved with the system 10 that are not necessarily players or users of the arena 14 and motion platforms 16. As such, the term “player” profile is used for ease of illustration. The player profile module 456 can be used to access public keys, user credentials, credit card or other payment information, as well as any stored digital assets or monetization data (e.g., licensing or rental agreements, etc.). While not shown separately in FIG. 20, the player profile module 456 can also be used to store stats for a player and enable them to share these stats outside of the system 10, e.g., on social media platforms and the like.

The booking module 458 enables users to book a time/game at any arena 14 in the system 10, assuming the user has sufficient funds. The booking module 458 can be integrated into other booking systems such as a website for an entertainment venue that includes the arena 14 (e.g., larger amusement park with an arena 14 provided as an attraction). The booking module 458 can also integrate with the player profile module 456 to have preference-based defaults or to link to loyalty programs and other third party systems and services that are associated with the system 10.

The creator space interface module 460 and audience interface modules 466 enable the PoS system 28 to communicate with, and if necessary integrate with, the creator space 24 and audience environment 26 respectively to provide PoS services to those entities. For example, the creator space interface module 460 can be used to enable users to pay for the ability to create content and/or to enable NFT minting and monetization.

The NFT/Blockchain module 462 can provide NFT wallets that integrate with the players' profiles and rental credits to be earned. That is, the NFT/Blockchain module 462 can provide an interface to the blockchain 30 to enable users to participate in the economy layered on the system 10 and to handle minted NFTs or NFTs created by others and used by a player.

The coin module 464 enables coin/token integration, e.g., by leveraging a stable cryptocurrency to allow for rental credits to be earned and redeemed in coins or tokens. It can be appreciated that a custom coin/token can also be created and used for the economy layered onto the system 10 for enabling transactions as described herein.

By accessing the creator space 24 and/or PoS system 28, players can select from contextually relevant NFTs or create their own. The system 10 can have stock or default NFTs that go with a game or can build in options or requirements to have each player perform certain selections before playing. This enables content with the system 10 to be monetized within the economy layered on the system 10. For example, each player could be required to select from a list of contextually relevant NFT's to join games (e.g., cars, tanks, avatars, games (large & mini)), wherein the owners of these NFTs earn a rental credit in cryptocurrency.

The players can also hold a non-consumable NFT such as a kart skin or mini game and this can be for personal use or to monetize by earning rental credits. This is in contrast to consumable or “burnable” NFTs, which can include digital assets used during a game, such as ammunition. This allows audience members to participate in high profile events through the purchase and provision of such consumable NFTs. For example, high profile event with celebrity or well-known influencers can have viewers with the ability to send consumable in-game weapons, powerups, potions, etc. to their favourite player. In an example scenario, a player could call for more shells, and a participant can send them an NFT of a shell. The moment the shell is “shot” the NFT is burnt but the NFT owner receives a video or image recorded “moment” of the player shooting his/her NFT as a new NFT. That is, digital assets that may themselves be NFTs can be used to create new in-game NFTs as a memento for a fan or audience member. It can be appreciated that the same principles can be applied to other organized live events such as birthday parties or corporate events where NFT moments can be created to provide as keepsakes or other take-home items.

The POS system 28 can use the player profile module 456 to store tokens, provide a marketplace, store vehicles and modifications, and store game bookings. The tokens allow for payment processing for token purchase. The marketplace enables the user to buy or sell in-game assets. The vehicles and modifications can allow the user to select a “current” vehicle and the appropriate modifications. These selections can be pushed out to a live game. The game bookings stored in the player profile module 456 can ensure that a minimum number of tokens are available, can display a calendar with their bookings, and can subtract tokens after successful bookings.

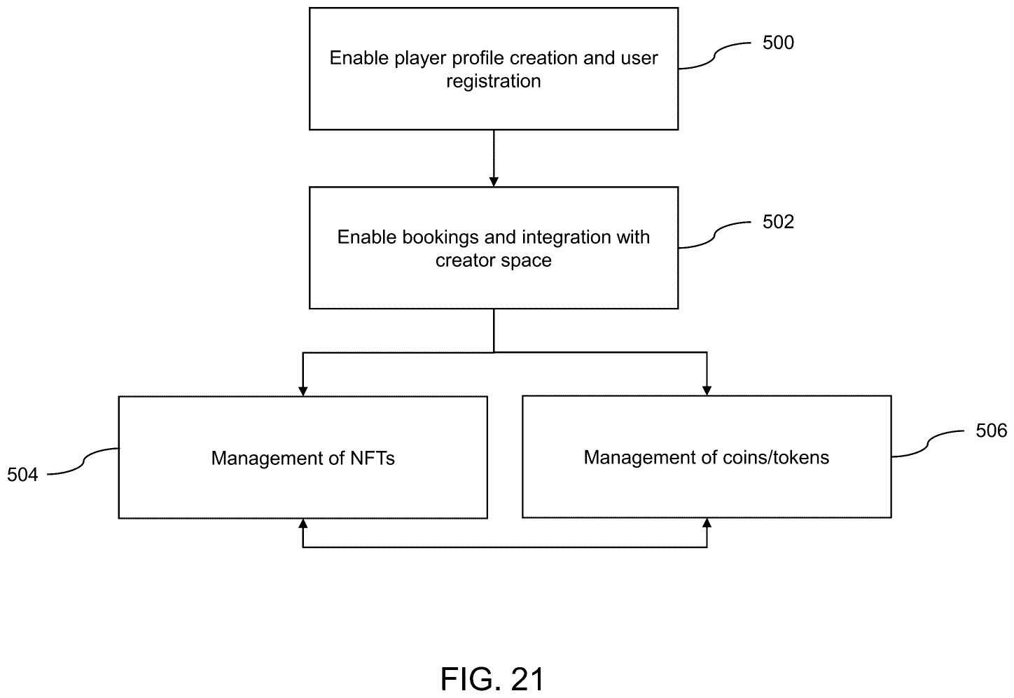

Referring now to FIG. 21, a flow chart is provided which illustrates operations performed by the PoS system 28 in communicating with the creator space 24, global server 22, and other entities in the system 10 to payment and monetization actions associated with the economy layered on the system 10. At step 500, the PoS system 28 enables a player profile to be created and a user 50 to be registered. With a profile created, the user 50 can then create bookings in the system 10 and the PoS system 28 can provide an integration with the creator space 24 such that the user 50 can associated certain content and/or digital assets with their booking. For example, if the user 50 is organizing a race at a specific arena 14 they may be asked to create or customize the track to be used and can be brought into the creator space 24 for same.

The PoS system 28 also provides the ability to manage NFTs and coins/tokens at steps 504 and 506 on an ongoing basis as the user 50 participates in the system 10.

As discussed herein the system 10 can provide a platform on which an economy can be provided to both users 50 and content creators for participating in the simultaneous physical and virtual experiences. This economy can be based on tokens and coins. The tokens can be exclusively used in-game for in-game purchases of NFTs etc. The system 10 can also launch a coin whose worth can be intrinsically tied to the tokens and allows users to convert tokens into coins, if they so choose.

The gameplay within the system 10 can provide various modes, including “fun run”, “championship”, and “pink slips” in one example. The fun run mode can be provided for players to either join online to try out the game or come to any location and just want to ride. Such users 50 can rent any vehicle or modification and can ride any track. If the owner of the NFT vehicle or modification is anyone other than the system 10, that owner can get rental income by way of in-game coins. If the NFT owner of the track is anyone other than the system 10, that user can get rewarded a flat fee for the track usage. This can create a revenue sharing scheme between the system 10 (collecting the fee) and the owner of the NFT. It should be noted that a creator can opt to sell his/her NFT and can have a royalty built into a smart contract.

In the championship mode, the driver has (at a minimum) minted an NFT vehicle that is his/hers. The driver amasses championship points for podium finishes and can purchase mods for the vehicle. The driver can also choose to “drive” for a constructor, should the constructor make an offer that is acceptable to the driver.

In the pink slips mode, a one-off race is provided, where championship drivers stake their rides as the prizes. The winner can either choose to hold winning cars or sell them in the marketplace.

Anything that can be created digitally within the system 10 can be made into an NFT. For example, custom assets can be created from user-generated content, such as custom tracks, custom rides, custom modifications, etc. Macro assets can be created by track owners, constructors, drivers and shop owners. Similarly, console or device assets can be created by users, audience members, etc.

For tracks, the system 10 can generate new tracks until such time where a sufficient amount of user generated tracks exist. Users 50 can make tracks within the constraints provided and mint them as an NFT. As part of the minting process, the creator can allow his/her track to be rented and earn revenue from each rental. The track owner can also chose to sell their track on the marketplace.

Constructors can be thought of as team owners, who can choose to create custom liveries for the karts, suits and helmets. Constructors can make offers to drivers to join their team—e.g., such that drivers who win and drive most often will provide best brand exposure. Championship drivers can compete individually for a Monthly Driver's Championship or as team if they are part of a constructor. Monthly Driver's Championship prizes can include cash or tokens. If a user signs up for a team, they can be made to wear the team's suits/helmets and ride in their karts. In this way, part of the value prop for the constructor is to have the driver sport the “team logo”. Shop owners are content creators that mint their NFTs for other users to buy/rent as discussed above.

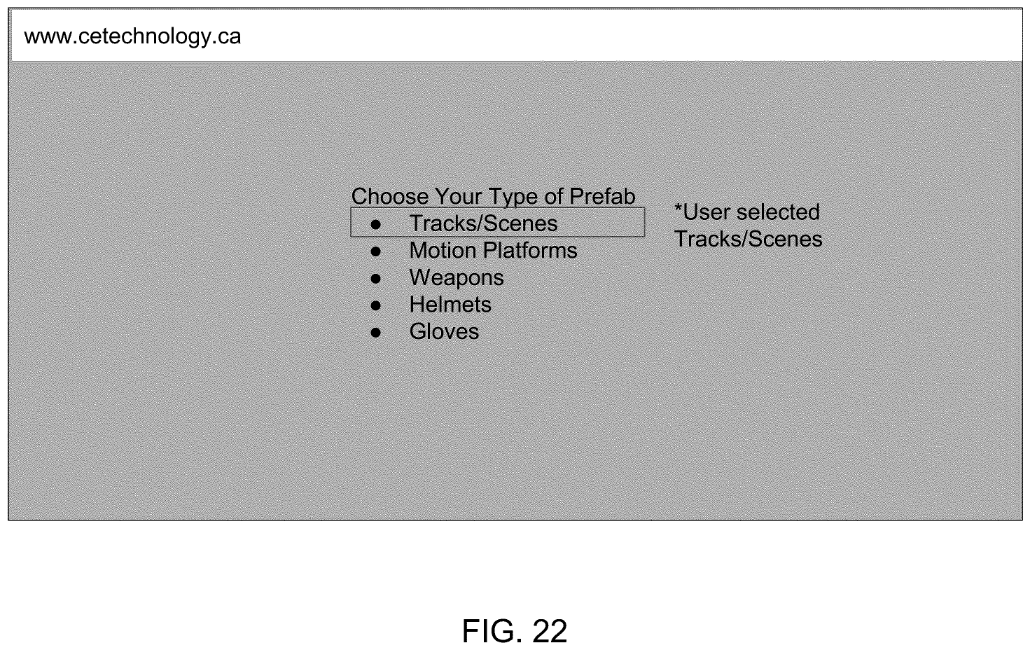

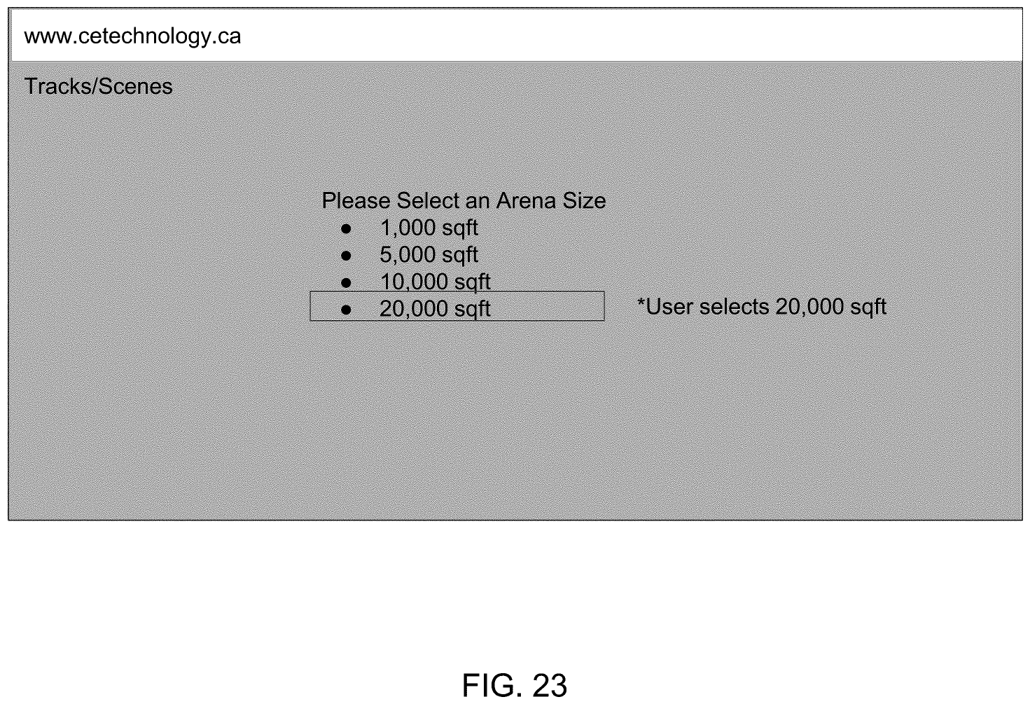

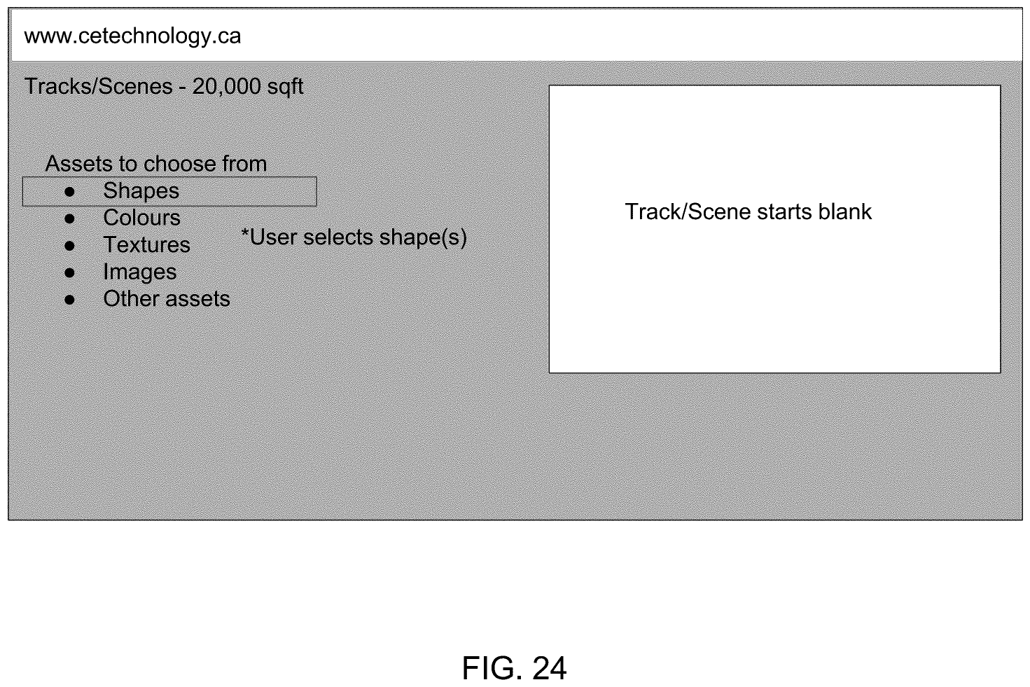

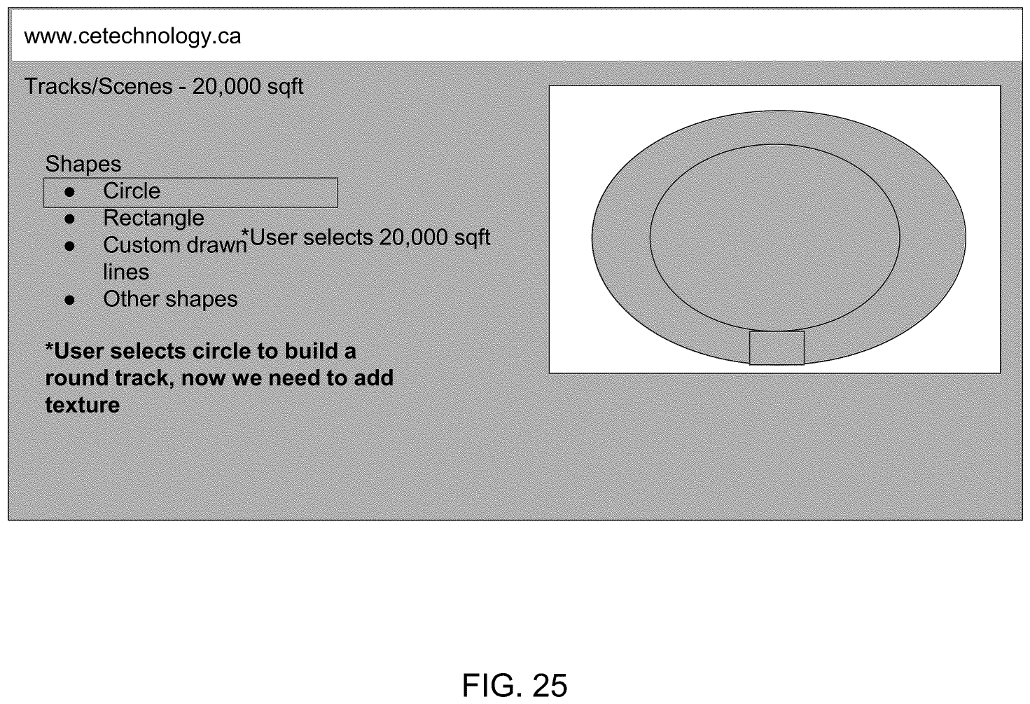

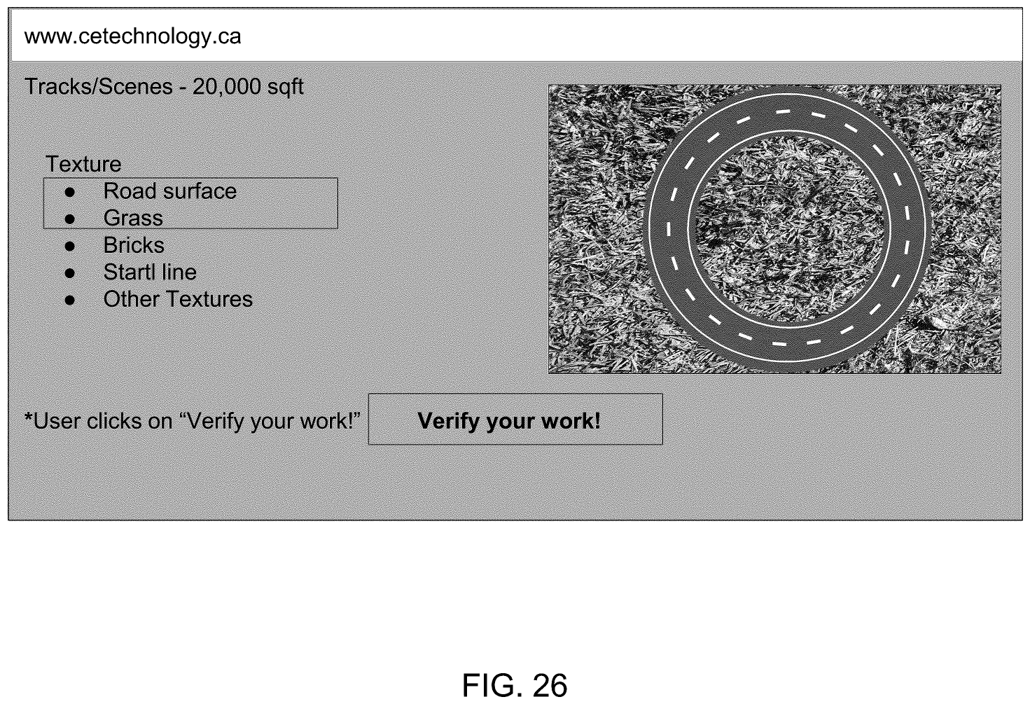

Referring now to FIGS. 22-33, various screen shots of user interfaces provided by the system 10 to interact with the creator space 24 and audience environment 26 are shown. Turning to FIG. 22, a prefab selection screen is shown in which users can select the type of prefab they wish to edit. The options can be based on what the system 10 makes available, which can change and evolve over time. As shown in FIG. 23, a track/scene selection screen is shown. Here, the users can be prompted to select the size of the arena for which they wish to design. The user may wish to select a size associated with an arena 14 that is proximate to them but can also select other sizes for other arenas 14 they plan to visit. Referring now to FIG. 24, a canvas screen is shown in which the users can begin with a blank canvas with the size locked per their selection. The user can then begin to add any available visual assets from defined menus or through customization tools. The items can be changed and updated at any time. For example, as shown in FIG. 25, the shape of the track is being selected as a circle by adding the shapes that they wish to build their track or scene on top of. Once the shapes are selected, the user is prompted to go to a color/texture menu to add further detail as shown in FIG. 26.

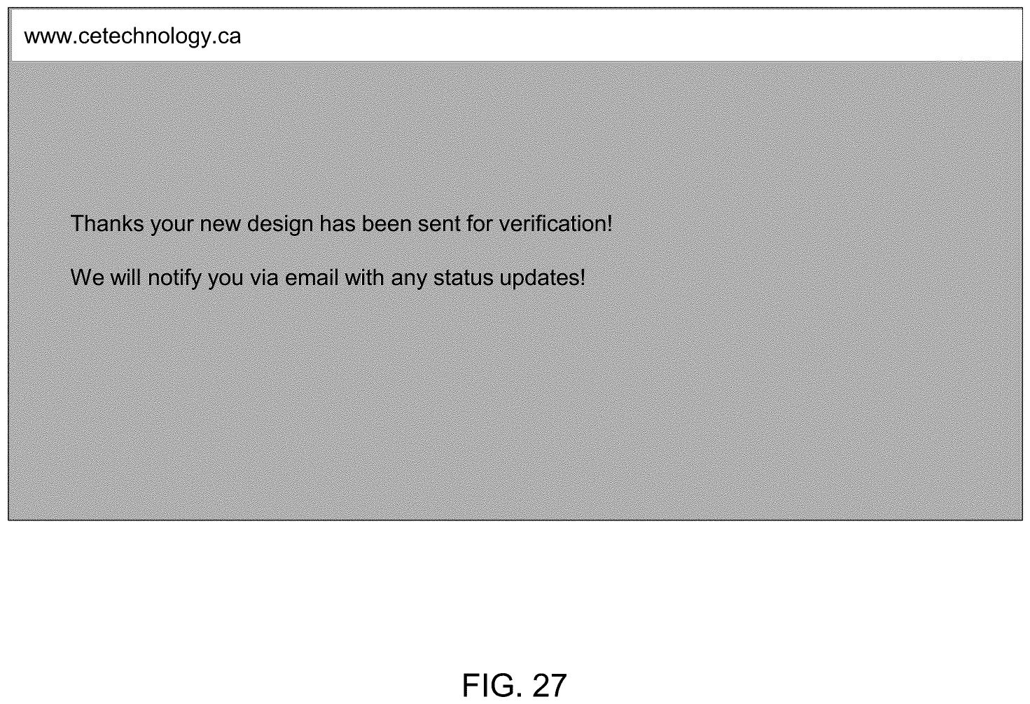

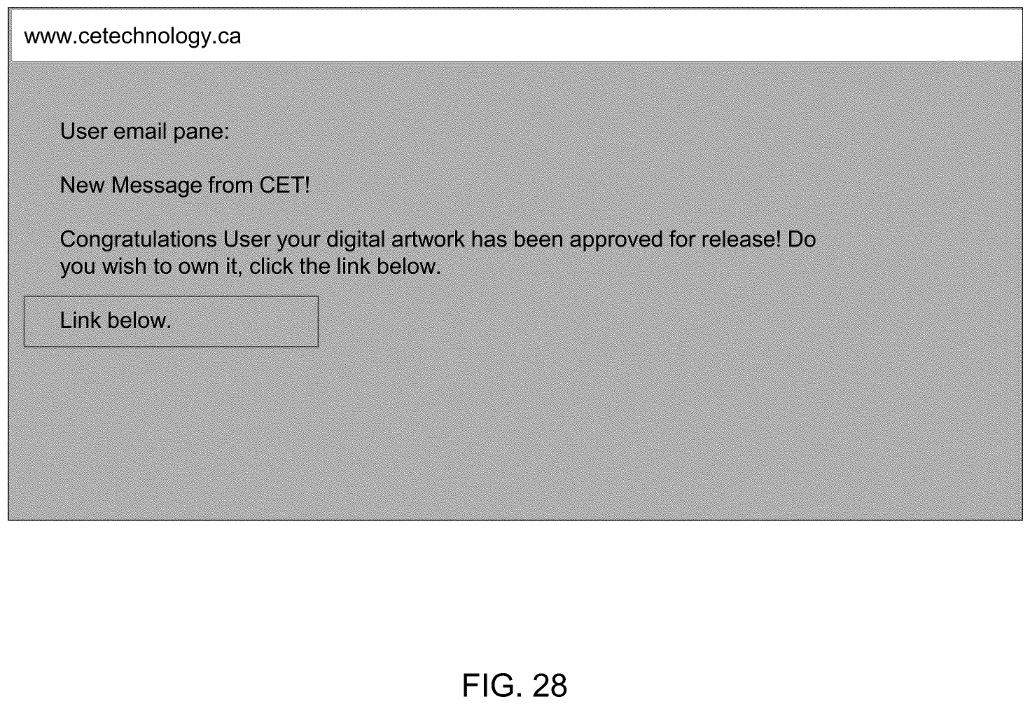

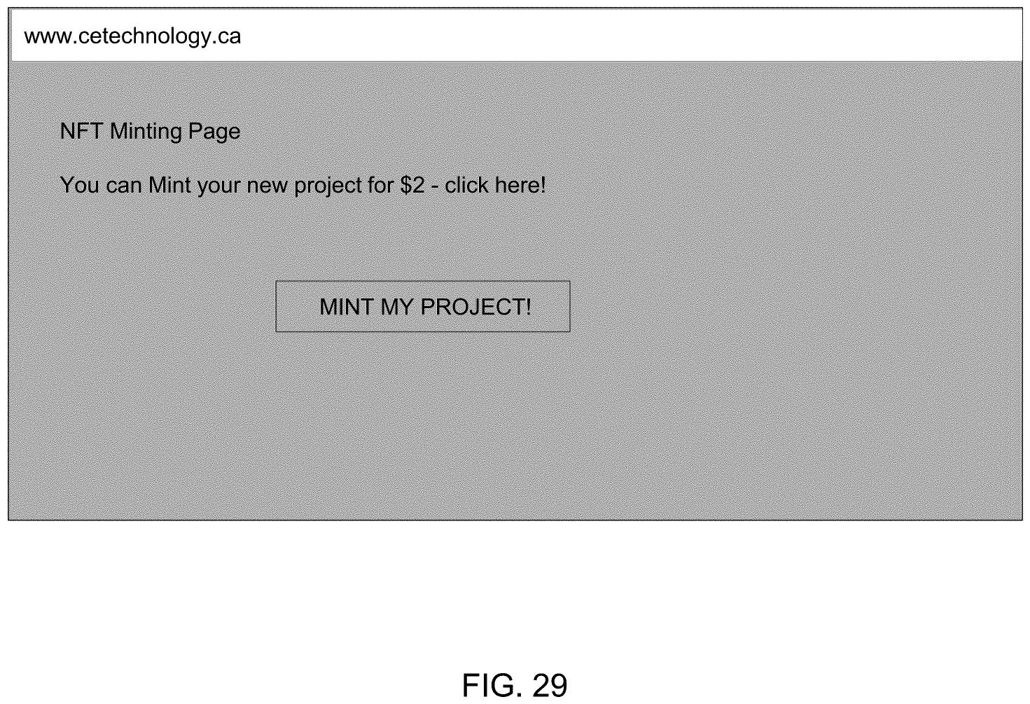

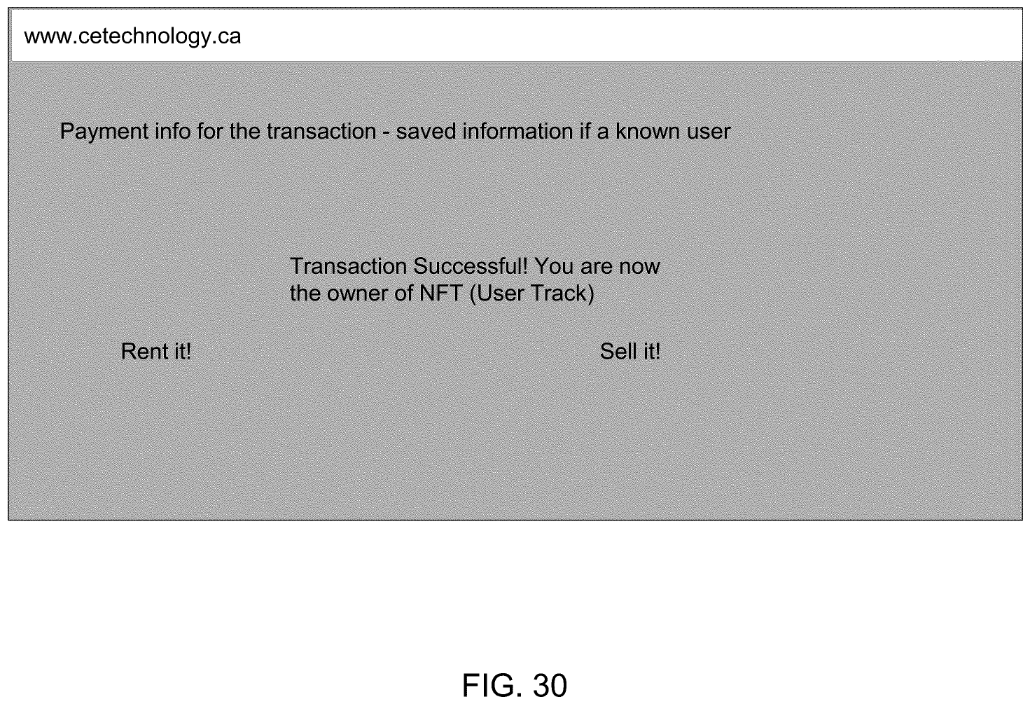

The texturing screen shown in FIG. 26 in this example allows the user to add road surfaces, grass, bricks, a starting line, and various other textures. By selecting “Verify Your Work” the user can submit their desired track so that they can mint this as an NFT subject to approvals by the creator space 24. FIG. 27 illustrates an example of an update message informing the user that their design has been sent for verification. The user's creation now goes for verification from the system 10, which can be an automated approval or can at least in part require a team member to review and load the newly form asset into the game environment to ensure changes have been made to the appropriate size, the textures scale properly, and all safety criteria are met. In FIG. 28, a reply message screen is shown wherein the user is notified that their design has received an approval. If the user wishes to own the asset, they can click on a link as illustrated. It may be noted that the user can create something only for a particular race and may not care to own the asset, but they can mint an NFT if they wish to keep or monetize their design. An NFT minting page is shown in FIG. 29. The NFT minting page also allows the user to rent or sell the digital asset as shown in FIG. 30. The rental option allows them to earn coins or tokens whenever others choose their track. Similarly, selling the track can result in a one-time payment to another user that wishes to own or rent the asset themselves.

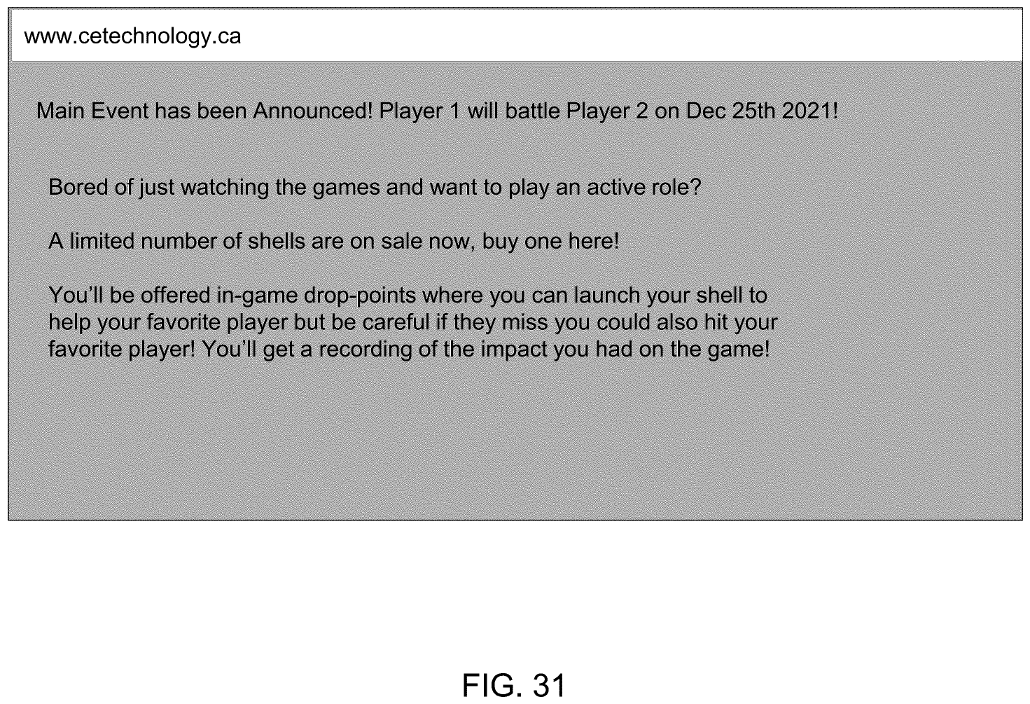

FIGS. 31-33 illustrates example screen shots of user interfaces that audience members can utilize within the audience environment 26. Referring first to FIG. 31, an event announcement page is shown. In this example, a main event is announced for Players 1 and 2. This event announcement also invites audience members to participate by buying “shells”. This allows those audience members to select in-game drop points where they can launch their shell to help their favorite player. The moment in this case is captured using a recording of the live event (in the virtual world) to capture the moment that audience member had an actual impact on the game. The system 10 can release a limited number of consumable NFTs or other assets for this purpose which can be purchased, traded, sold etc. before and/or during the game.

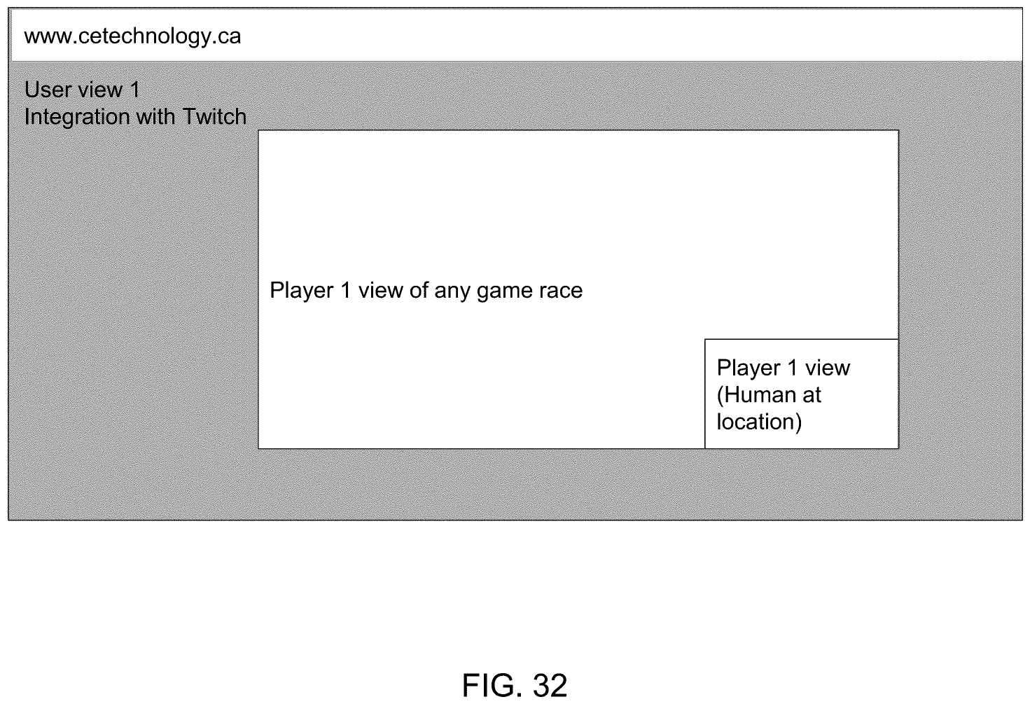

As shown in FIG. 32, a viewing screen can be provided in the audience environment 26, which in this example integrates with Twitch to provide both Player 1's view of the race or game and a view of the physical environment to gauge real world reactions by that player during game play. That is, the system 10 can live stream both the virtual and physical worlds associated with the players.

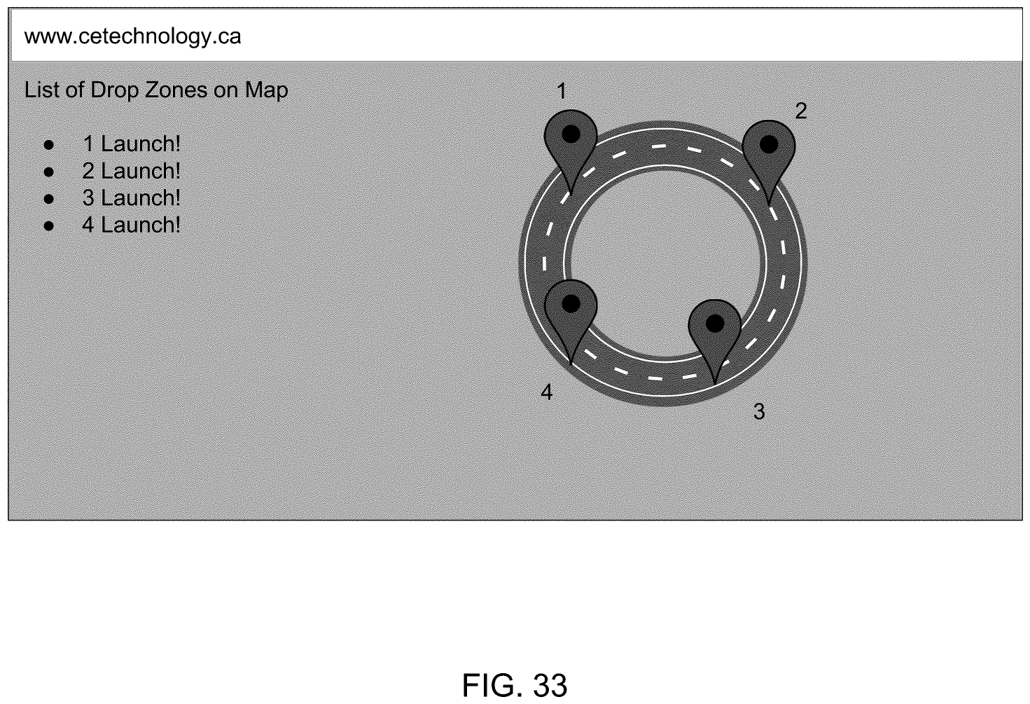

FIG. 33 illustrates a drop zone map which can be provided using a browser extension or web integration to allow the user to interactively place their consumable assets on the track to indicate where they will be launched. For example, users can drop their in-game NFT (gun, ammo, shell, power up, banana peel, etc.) at given locations on the map. They will try to help their favorite player but they could also hurt them as the assets will stay on the track until they are interacted with in-game. In an example, the user could drop a power up for your favorite player but he/she misses it, the other player could pick it up.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, SSDs, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10 (or entities within the system 10 as shown in FIG. 1), any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A virtual reality-enhanced motion platform, comprising:
at least one drive unit to move the motion platform;
at least one control system;
a seating unit for a user;
a steering mechanism controlled by the user to direct the at least one drive unit to move the motion platform;
at least one virtual reality headset coupled to the motion platform and wearable by the user to integrate a combined virtual and physical experience;
at least one communication module to communicate with a server to exchange data in providing an experience that operates the motion platform and virtual reality headset at the same time to provide the integrated virtual and physical experience; and
a power source.

2. The motion platform of claim 1, further comprising at least one tracking module for tracking the motion platform within an arena in which the motion platform is being used.

3. The motion platform of claim 1, comprising a plurality of swappable sub-systems or sub-components that are removable and replaceable.

4. The motion platform of claim 1, wherein the power source comprises a plurality of batteries, each battery being swappable from the motion platform.

5. The motion platform of claim 1, configured to perform at least one motion in addition to planar translation: tilt, roll, yaw, heave, and/or haptic feedback.

6. The motion platform of claim 1, wherein the at least one drive unit comprises a plurality of swerve drive units to permit multi-directional movements.

7. The motion platform of claim 1, comprising a plurality of seating units.

8. The motion platform of claim 7, wherein at least two seating units are independently moveable.

9. An arena for providing combined virtual and physical experiences, the arena comprising:
a surface on which a plurality of motion platforms can move within the arena;
a tracking system to track movements of the motion platforms relative to the surface and to each other; and
an arena server to communicate with each motion platform to provide the combined virtual and physical experience.

10. The arena of claim 9, wherein the tracking system comprises a plurality of anchors communicable with tags on the motion platforms using a communication protocol.

11. The arena of claim 9, further comprising at least one area separate from the surface to load and unload users.

12. The arena of claim 11, wherein the at least one area comprises a plurality of stations to each perform an unload, provisioning, loading or starting operation.

13. The arena of claim 12, wherein the arena server communicates with the motion platforms to provide asynchronous operations using the plurality of stations.

14. The arena of claim 13, wherein the arena server provides virtual reality content that varies depending on in which station is the motion platform.

15. The arena of claim 9, wherein the arena server is in communication with a global server to enable motion platforms in multiple arenas to have the same experience.

16. The arena of claim 9, further comprising an attendant area to permit attendants to interact with the motion platforms.

17. A system comprising:
at least one motion platform in an arena; and
a server to communicate with each motion platform by communicating with at least one virtual reality headset coupled to each motion platform to integrate a combined virtual and physical experience.

18. The system of claim 17, comprising a motion platform.

19. The system of claim 17, wherein the server comprises an arena server.

20. The system of claim 19, wherein the arena server communicates with a global server.
